(19) United States
(12) Patent Application Publication
(10) Pub. No.: US 2024/0314019 A1
(43) Pub. Date: Sep. 19, 2024

(54) SYSTEM TO AUTOMATE NETWORK ASSESSMENT

(71) Applicant: NetBrain Technologies, Inc., Burlington, MA (US)

(72) Inventors: Lingping Gao, Burlington, MA (US); Yanguo Guo, Burlington, MA (US); Qingyuan Ni, Burlington, MA (US); Long Zeng, Burlington, MA (US); Jiyu Tian, Burlington, MA (US); Xinfeng Xia, Burlington, MA (US); Zhongxi Yuan, Burlington, MA (US); Guangdong Liao, Burlington, MA (US)

(73) Assignee: NetBrain Technologies, Inc., Burlington, MA (US)

(21) Appl. No.: 18/675,940

(22) Filed: May 28, 2024

Related U.S. Application Data
(63) Continuation-in-part of application No. 18/172,061, filed on Feb. 21, 2023.
(63) Continuation-in-part of application No. 18/172,044, filed on Feb. 21, 2023.
(63) Continuation-in-part of application No. 17/729,275, filed on Apr. 26, 2022.
(63) Continuation-in-part of application No. 17/729,182, filed on Apr. 26, 2022.
Application No. 18/172,044 is a continuation-in-part of application No. 17/729,182, filed on Apr. 26, 2022.
Application No. 17/729,182 is a continuation-in-part of application No. 17/729,275, filed on Apr. 26, 2022.
Application No. 18/172,061 is a continuation-in-part of application No. 17/729,182, filed on Apr. 26, 2022.
Application No. 17/729,182 is a continuation-in-part of application No. 17/729,275, filed on Apr. 26, 2022.
(63) Continuation-in-part of application No. 18/540,292, filed on Dec. 14, 2023.
(60) Provisional application No. 63/515,539, filed on Jul. 25, 2023.
(60) Provisional application No. 63/311,679, filed on Feb. 18, 2022.
(60) Provisional application No. 63/311,679, filed on Feb. 18, 2022.
(60) Provisional application No. 63/179,782, filed on Apr. 26, 2021.
(60) Provisional application No. 63/179,782, filed on Apr. 26, 2021.
(60) Provisional application No. 63/486,149, filed on Feb. 21, 2023.

(51) Int. Cl. H04L 41/0631; H04L 43/08

(52) U.S. Cl. CPC H04L 41/0631; H04L 43/08

(57) ABSTRACT

Network management automation may use network intent (NI) which represents a network design and baseline configuration for that network or network devices with the ability to diagnose deviation from the baseline configuration. This may include automation of the diagnosis of repetitive problems and the enforcement of preventive measures across a network. This automation may be through an automation data table (ADT), which is an extended global data table for managing network assets and network intents associated with those network assets. ADT is a database for intents, supporting intent creation and replication, and can be used in the PDAS system.

### PRIORITY

This application claims priority to Provisional Patent Application No. 63/515,539, filed on Jul. 25, 2023, entitled AUTOMATED DATA TABLE, the entire disclosure of which is herein incorporated by reference.

This application claims priority as a continuation-in-part to U.S. application Ser. No. 18/540,292, filed on Dec. 14, 2023, entitled INTENT BASED AUTOMATION SYSTEM, which claims priority to Provisional Patent Application No. 63/486,149, filed on Feb. 21, 2023, entitled INTENT BASED AUTOMATION SYSTEM, the entire disclosures of each are herein incorporated by reference.

This application claims priority as a continuation-in-part to U.S. application Ser. No. 18/172,061, filed Feb. 21, 2023, entitled TRIGGERED AUTOMATION FRAMEWORK, and U.S. application Ser. No. 18/172,044, filed Feb. 21, 2023, entitled NETWORK INTENT CLUSTER, each of which claims priority to Provisional Patent Application No. 63/311,679, filed on Feb. 18, 2022, entitled PROBLEM DIAGNOSIS AUTOMATION SYSTEM (PDAS) INCLUDING NETWORK INTENT CLUSTER (NIC), TRIGGERED DIAGNOSIS, AND PERSONAL MAP, and each of which claims priority as a continuation-in-part to U.S. application Ser. No. 17/729,275, filed on Apr. 26, 2022, entitled NETWORK ADAPTIVE MONITORING, and to U.S. application Ser. No. 17/729,182, filed on Apr. 26, 2022, entitled NETWORK INTENT MANAGEMENT AND AUTOMATION, both of which claim priority to Provisional Patent Application No. 63/179,782, filed on Apr. 26, 2021, entitled INTENT-BASED NETWORK AUTOMATION, the entire disclosures of each are herein incorporated by reference.

This application claims priority as continuation-in-part to U.S. application Ser. No. 17/729,275, filed on Apr. 26, 2022, entitled NETWORK ADAPTIVE MONITORING, and to U.S. application Ser. No. 17/729,182, filed on Apr. 26, 2022, entitled NETWORK INTENT MANAGEMENT AND AUTOMATION, both of which claim priority to Provisional Patent Application No. 63/179,782, filed on Apr. 26, 2021, entitled INTENT-BASED NETWORK AUTOMATION, the entire disclosures of each are herein incorporated by reference.

### BACKGROUND

In the modern computer age, businesses rely on an electronic network to function properly. Computer network management and troubleshooting are complex. There are thousands of shell scripts and applications for different network problems. The available, but poorly documented solutions can be overwhelming for junior network engineers. Most network engineers learn troubleshooting through reading the manufacturer's manual or internal documentation from the company's documentation department. But the effectiveness varies. For instance, the troubleshooting knowledge captured in a document can only be helpful if the information is accurate and the user correctly identifies the problem. Many companies have to conduct extensive training for junior engineers. The conventional way of network troubleshooting requires a network professional to manually run a set of standard commands and processes for each device. However, to become familiar with those commands, along with each of their parameters, takes years of practice. Also, complicated troubleshooting methodology is often hard to share and transfer. Therefore, even though a similar network problem happens repeatedly, each troubleshooting instance may still have to start from scratch. However, networks are getting more and more complex, and it is increasingly difficult to manage them efficiently with traditional methods and tools.

Network management teams provide two functions: to deliver services required by the business and to ensure minimized downtime. The first function may be dominated by projects, such as data centers, cloud migration, or implementing quality of service (QOS) for a voice or video service. The second function, minimizing downtime, may be more critical in impacting a company's revenue and reputation. Ensuring minimal downtime can include preventing outages from happening and resolving outages as soon as possible. Two measurements for an outage may include Mean Time Between Failure (MTBF) and Mean Time to Repair (MTTR).

Network management may utilize new methodologies and processes to accommodate the global shift to digital technologies. To manage the network efficiently with tactical, manual approaches using legacy mechanisms to build, operate, and troubleshoot may need to improve.

### SUMMARY

This disclosure generally relates to network management automation using network intent (NI). Network intent (NI) represents a network design and baseline configuration for that network or network devices with the ability to diagnose deviation from the baseline configuration. This may include a Problem Diagnosis Automation System (PDAS), which automates the diagnosis of repetitive problems and the enforcement of preventive measures across a network. Specifically, this automation may be through an Automation Data Table (ADT), which is an extended global data table for managing network assets and network intents associated with those network assets. ADT is a database for intents, supporting intent creation and replication, and can be used in the PDAS system.

In one embodiment, a method includes utilizing an automation data table (ADT) in the network assessment and troubleshooting, including receiving the ADT and associated data in that ADT; automating network assessment and monitoring of a network based on the ADT, wherein the automation is intent-based; and automating troubleshooting a network problem based on the ADT.

In another embodiment, a method includes generating an automation data table (ADT). The method includes: generating the base table for the network assets; associating the automation assets with the network assets; and generating the diagnosing results using the determined intent with organized assets.

In another embodiment, a method for diagnosis in a network includes: issuing a probe on a subset of devices on the network; parsing, with the probe, alert information from the subset of the network to identify an anomaly; and diagnosing an issue for more devices than just the subset of the network based on the anomaly detected by the probe.

In another embodiment, a method for diagnosis in a network includes: configuring a probe for identifying an error from a subset of devices on the network; determining a condition for the error identified by the probe compared with an automated data table; calculating a coverage from the probe, wherein the coverage comprises each of the devices in the subset of devices; and identifying, with the probe, the error from within the coverage.

In another embodiment, a method for network maintenance includes: issuing a probe to check for route changes in a network; identifying each route in the network associated with the route changes in the network based on a trigger condition; determining which of the identified routes are critical; and monitoring the determined critical routes; and triggering an alert for a subset of the network based on the monitoring of the determined critical routes.

### BRIEF DESCRIPTION OF THE DRAWINGS

The system and method may be better understood with reference to the following drawings and descriptions. Non-limiting and non-exhaustive embodiments are described with reference to the following drawings. The components in the drawings are not necessarily to scale, emphasis instead being placed upon illustrating the principles of the invention. The drawings, like referenced numerals, designate corresponding parts throughout the different views.

FIG. 1 illustrates a block diagram of an example network system.

FIG. 2 illustrates the input and output of the Problem Diagnosis Automation System (PDAS).

FIG. 3 illustrates a system organization with an Automation Data Table (ADT).

FIG. 4 illustrates an example Automation Data Table (ADT).

FIG. 5 illustrates an example process to create an Automation Data Table (ADT).

FIG. 6 illustrates an example management of an Automation Data Table (ADT).

FIG. 7 illustrates an example Folder Tree structure.

FIG. 8 illustrates an example of Table Data in an ADT.

FIG. 9 illustrates a Base Table Builder.

FIG. 10 illustrates a Column Group Builder.

FIG. 11 illustrates an interface for building a base table in an Automation Data Table Builder.

FIG. 12 illustrates an interface for building a column group tab in an Automation Data Table Builder.

FIG. 13 illustrates an interface for updating a schedule in an Automation Data Table Builder.

FIG. 14 illustrates an interface for adding data manually in an Automation Data Table Builder.

FIG. 15 illustrates an interface for creating tags in an Automation Data Table Builder.

FIG. 16 illustrates a process for creating an ADT with an Automation Data Table Builder.

FIG. 17 illustrates an interface for using the Application Path for ADT building.

FIG. 18 illustrates how the intent template works in Column Group Builder.

FIG. 19 illustrates an interface for the Column Group Builder when the Intent Template method is selected.

FIG. 20 illustrates a process for importing CSV in Column Group Builder.

FIG. 21 illustrates an interface showing the importation of CSV in Column Group Builder.

FIG. 22 illustrates a probe triggering an automation process associated with the ADT automation assets.

FIG. 23 illustrates a monitoring probe used in a Column Group Builder.

FIG. 24 illustrates the selection of a monitoring probe.

FIG. 25 illustrates ADT usage across different functions.

FIG. 26 illustrates network assessment with ADT.

FIG. 27 illustrates an example Summary Dashboard.

FIG. 28 illustrates an example interface for a benchmark task.

FIG. 29 illustrates example commands for the ADT dataset.

FIG. 30 illustrates an interface for importing files.

FIG. 31 illustrates an interface for adding commands to an ADT dataset.

FIG. 32 illustrates an interface for scheduling execution with a trigger.

FIG. 33 illustrates an example intent dashboard.

FIG. 34 illustrates example intent results on the intent dashboard.

FIG. 35 illustrates an example view summary for the intent dashboard.

FIG. 36 illustrates an example process for installing ADT intents for TAF.

FIG. 37 illustrates an example triggering of diagnosis using ADT intents.

FIG. 38 illustrates an example interface for triggering ADT intent.

FIG. 39 illustrates an example interface for matching ADT intents.

FIG. 40 illustrates an example interface for ADT configuration for preventative automation.

FIG. 41 illustrates an example of a looking glass probe process for executing a matched intent.

FIG. 42 illustrates an example process for ADT creation based on a looking glass probe.

FIG. 43 illustrates an example process for ADT creation triggered by a looking glass probe.

FIG. 44 illustrates an example interface for selecting an intent timer to trigger selected intents.

FIG. 45 illustrates an example interface for a monitoring probe.

FIG. 46 illustrates an example interface for an auto probe.

FIG. 47 illustrates an example interface for using the auto intent from an intent template.

FIG. 48 illustrates an example interface for replicating path intent.

FIG. 49 illustrates example follow-up diagnoses.

FIG. 50 illustrates an example interface for follow-up intent.

FIG. 51 illustrates an example of depths for follow-up intent.

FIG. 52a illustrates an example interface for finding automation assets.

FIG. 52b illustrates an example interface for selecting intent for automation assets.

### DETAILED DESCRIPTION

This disclosure generally relates to network management automation using network intent (NI). Network intent (NI) represents a network design and baseline configuration for that network or network devices with the ability to diagnose deviation from the baseline configuration. This may include a Problem Diagnosis Automation System (PDAS), which automates the diagnosis of repetitive problems and the enforcement of preventive measures across a network. Specifically, this automation may be through an automation data table (ADT), which is an extended global data table for managing network assets and network intents associated with those network assets. ADT is a database for intents, supporting intent creation and replication, and can be used in the PDAS system.

Network management automation may use network intent (NI), which represents a network design and baseline configuration for that network or network devices with the ability to diagnose deviation from the baseline configuration. This may include automation of the diagnosis of repetitive problems and the enforcement of preventive measures across a network.

Network problems may be organized by a Ticket System in the form of incidents. Those network problems may be repetitive: identical or similar problems happen repeatedly but are diagnosed the same way each time. Often, those problems are preventable, caused by misconfiguration, performance degradation, or security violations. However, a lack of automated methods to enforce the design rules, best practices, or security policy may prevent the remediation of those problems effectively.

Problem Diagnosis Automation System (PDAS) may address those issues. Specifically, PDAS may include automating the Diagnosis of the repetitive problem and automating the enforcement of preventive measures across the entire network. PDAS automates the Diagnosis of repetitive problems and enforces preventive measures across the entire network. The PDAS system may be built on Network Intent as described in U.S. Pat. Pub. No. 2022/0393942 with network intent templates, the entire disclosure is incorporated by reference. The PDAS system may further include a Network Intent Cluster as described in the U.S. application Ser. No. 18/172,044, which is herein incorporated by reference. There may be a Triggered Automation Framework described in U.S. Pat. Pub. No. 2023/0198866. There may be monitoring of adaptive networking as described in U.S. Pat. Pub. No. 2022/0360509, which is incorporated by reference.

Automation assets across the network include Network Intent (NI) or Executable Runbook (RB) inside the no-code platform. Automation is executed in response to an external symptom in three successive methods, namely interactive, triggered, and preventive. Execution output is organized inside an incident pane for each incident. A Network Intent Cluster (NIC) clones an NI across the network to create a group of NIs (member NIs) with the same design or logic. NIC may be created from a seed NI via no coding process. In PDAS, a subset of Member NIs can be automatically executed according to the user-defined condition based on the member device, the member NI tags, or signature variables. A Triggered Automation Framework (TAF) matches the incoming API calls from a 3rd party system to current incidents and installs the automation (e.g., NI/NIC) to be triggered for each call. It may include an integrated IT System defining the scope and data of the incoming API calls; Incident Type to match a call to an Incident; and Triggered Diagnosis to define what and how the NIC/NI is executed.

Network Intent Template (NIT) may simplify the intent's replication as described herein. Users may define NIT for any network intent (NI) with the single-device diagnosis by setting the device qualifications and the critical variables to be auto-tested. The Intent with the template configured may be cloned on the fly after it is decoded and installed in the Intent Library. The intent library is the central console to install Intent and NIT in the PDAS system. It may enable the backend decoding service to qualify the devices against the template setting, update the baseline data, enable the auto intent to create the intents in the map (e.g., Auto Intent for the IAF), install the Intent in TAF and PAF, and execute the configure orchestration files downloaded and then for installing the intents automatically.

A Triggered Automation Framework (TAF) matches the incoming API calls from a 3rd party system to current incidents and installs the automation (e.g., network intent or network intent clusters) to be triggered for each call. It may include an Integrated IT System defining the scope and data of the incoming API calls, an Incident Type to match a call to an Incident, and a Triggered Diagnosis to define the execution of the network intent or network intent clusters.

Network intent clusters (NIC) expand Network Intent (NI) scope from a specific network design to one type of network design with similar diagnosis logic. A large network can have millions of NIs, and it may be time-consuming to add these NIs manually. The NIC system can discover and create these NIs automatically. While NI effectively documents and validates a network design, it may apply to at least one network device or a set of devices at a time. Therefore, it can take many repetitive efforts to create NIs for a large network. NIC may be designed to expand the logic of a NI (seed NI) from one or a set of devices to the whole network. Furthermore, NIC may be triggered to run in the Triggered Automation Framework (TAF), and its results can significantly reduce the MTTR. NIC may not require coding skills and provides an intuitive user interface for creating and debugging. For example, a NI may monitor whether a failover occurs between a pair of network devices (the failover may cause performance issues such as slow applications). Upon identification, NIC can replicate the logic to all other pairs of network devices in the network without any coding.

Reference will now be made in detail to exemplary embodiments of the invention, examples of which are illustrated in the accompanying drawings. When appropriate, the same reference numbers are used throughout the drawings to refer to the same or like parts. The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, and some areas or elements may be expanded to help improve understanding of embodiments of the invention.

The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present disclosure, and that the detailed description is not to be taken in a limiting sense, and that elements may be differently positioned, or otherwise noted as in the appended claims without requirements of the written description being required thereto.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The aspects of the present disclosure may be described herein in terms of functional block components and various processing steps. It should be appreciated that such functional blocks may be realized by any number of hardware and/or software components configured to perform the specified functions. For example, these aspects may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting languages such as C, C++, Java, COBOL, assembler, PERL, Python, or the like, with the various algorithms being implemented with any combination of data structures, objects, processes, routines, or other programming elements. Further, it should be noted that the present disclosure may employ any number of conventional techniques for data transmission, signaling, data processing, network control, and the like.

The particular implementations shown and described herein are for explanatory purposes and are not intended to otherwise be limiting in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the disclosure.

As will be appreciated by one of ordinary skill in the art, aspects of the present disclosure may be embodied as a method or a system. Furthermore, these aspects of the present disclosure may take the form of a computer program product on a tangible computer-readable storage medium having computer-readable program-code embodied in the storage medium. Any suitable computer-readable storage medium may be utilized, including hard disks, CD-ROM, optical storage devices, magnetic storage devices, and/or the like. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

As used herein, the terms “user,” “network engineer,” “network manager,” “network developer” and “participant” shall interchangeably refer to any person, entity, organization, machine, hardware, software, or business that accesses and uses the system of the disclosure. Participants in the system may interact with one another either online or offline.

Communication between participants in the system of the present disclosure is accomplished through any suitable communication means, such as, for example, a telephone network, intranet, Internet, extranet, WAN, LAN, personal digital assistant, cellular phone, online communications, off-line communications, wireless network communications, satellite communications, and/or the like. One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like.

In network troubleshooting, a network engineer may use a set of commands, methods, and tools, either standard or proprietary. For example, these commands, methods, and tools may include the following items:

The Command Line Interface (CLI): network devices often provide CLI commands to check the network status or statistics. For example, in a Cisco IOS switch, the command “show interface” can be used to show the interface status, such as input errors.

Configuration management: a tool used to find differences of configurations of network devices in a certain period. This is important since about half of the network problems are caused by configuration changes.

The term “Object” refers to the term used in computer technology, in the same meaning as “object oriented” programming languages (such as Java, Common Lisp, Python, C++, Objective-C, Smalltalk, Delphi, Java, Swift, C #, Perl, Ruby, and PHP). It is an abstracting computer logic entity that envelops or mimics an entity in the real physical world, usually possessing an interface, data properties and/or methods.

The term “Device” refers to a data object representing a physical computer machine (e.g., printer, router) connected in a network or an object (e.g., computer instances or database instances on a server) created by computer logic functioning in a computer network.

The term “Q-map” or “Qmap” refers to a map of network devices created by the computer technology of NetBrain Technologies, Inc. that uses visual images and graphic drawings to represent the topology of a computer network with interface property and device property displays through a graphical user interface (GUI). Typically, a computer network is created with a map-like structure where a device is represented with a device image and is linked with other devices through straight lines, pointed lines, dashed lines and/or curved lines, depending on their interfaces and connection relationship. Along the lines, also displayed are the various data properties of the device or connection.

The term “Qapp” refers to a built-in or user-defined independently executable script or procedure generated through a graphical user interface as per technology available from NETBRAIN TECHNOLOGIES, INC.

The term “GUI” refers to a graphical user interface and includes a visual paradigm that offers users a plethora of choices. GUI paradigm or operation relies on windows, icons, mouse, pointers, and scrollbars to display the set of available files and applications graphically. In a GUI-based system, a network structure may be represented with graphic features (icons, lines and menus) that represent corresponding features in a physical network in a map. The map system may be referred to as a Qmap and is further described with respect to U.S. Pat. Nos. 8,386,593, 8,325,720, and 8,386,937, the entire disclosure of each of which is hereby incorporated by reference. After a procedure is created, it can be run in connection with any network system. Troubleshooting with a proposed solution may just take a few minutes instead of hours or days traditionally. The troubleshooting and network management automation may be with the mapping of the network along with the NETBRAIN QAPP (Qapp) system. The Qapp system is further described with respect to U.S. Pat. Nos. 9,374,278, 9,438,481, U.S. Pat. Pub. No. 2015/0156077, U.S. Pat. Pub. No. 2016/0359687, and U.S. Pat. Pub. No. 2016/0359688, the entire disclosure of each of which is hereby incorporated by reference.

The term “Step” refers to a single independently executable computer action represented by a GUI element, that obtains, or causes a network result from, or in, a computer network; a Step can take the form of a Qapp, a system function, or a block of plain text describing an external action to be executed manually by a user, such as a suggestion of action, “go check the cable.” Each Step is thus operable and re-usable by a GUI operation, such as mouse cursor drag-and-drop or a mouse click.

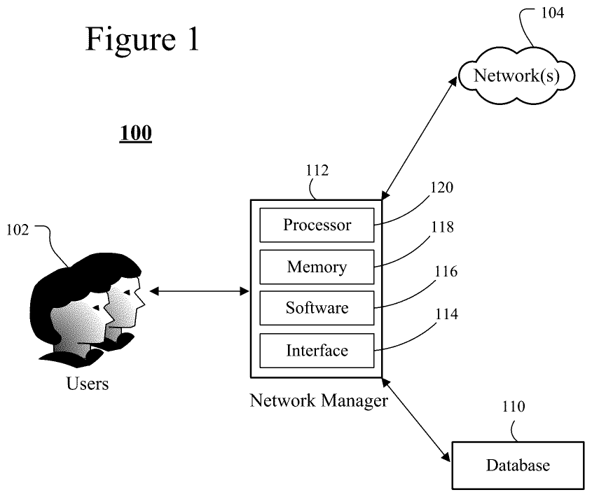

FIG. 1 illustrates a block diagram of an example network system 100. The system 100 may include functionality for managing network devices with a network manager 112. The network system 100 may include one or more networks 104, which includes any number of network devices (not shown) that are managed. The network(s) 104 devices may be any computing or network device, which belongs to network 104, such as a data center or enterprise network. Examples of devices include, but are not limited to, routers, access points, databases, printers, mobile devices, personal computers, personal digital assistants (“PDA”), cellular phones, tablets, other electronic devices, or any network devices. The devices in the network 104 may be managed by the network manager 112.

The network manager 112 may be a computing device for monitoring or managing devices in a network, including performing automation tasks for the management, including network intent analysis and adaptive monitoring automation. In other embodiments, the network manager 112 may be referred to as a network intent analyzer or adaptive monitor for a user 102. The network manager 112 may include a processor 120, a memory 118, software 116 and a user interface 114. In alternative embodiments, the network manager 112 may be multiple devices to provide different functions, and it may or may not include all of the user interface 114, the software 116, the memory 118, and/or the processor 120.

The user interface 114 may be a user input device or a display. The user interface 114 may include a keyboard, keypad, or cursor control device, such as a mouse, joystick, touch screen display, remote control, or any other device operative to allow a user or administrator to interact with the network manager 112. The user interface 114 may communicate with any of the network devices in the network 104, and/or the network manager 112. The user interface 114 may include a user interface configured to allow a user and/or an administrator to interact with any of the components of the network manager 112. The user interface 114 may include a display coupled with the processor 120 and configured to display output from the processor 120. The display (not shown) may be a liquid crystal display (LCD), an organic light emitting diode (OLED), a flat panel display, a solid-state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the network manager 112 may include a central processing unit (CPU), a graphics processing unit (GPU), a digital signal processor (DSP), or other types of processing devices. The processor 120 may be a component in any one of a variety of systems. For example, the processor 120 may be part of a standard personal computer or a workstation. The processor 120 may be one or more general processors, digital signal processors, application-specific integrated circuits, field programmable gate arrays, servers, networks, digital circuits, analog circuits, combinations thereof, or other known or later developed devices for analyzing and processing data. The processor 120 may operate in conjunction with a software program (i.e., software 116), such as code generated manually (i.e., programmed). The software 116 may include the Data View system and tasks that are performed as part of the management of the network 104, including the generation and usage of Data View functionality. Specifically, the Data View may be implemented from software, such as the software 116.

The processor 120 may be coupled with the memory 118, or the memory 118 may be a separate component. The software 116 may be stored in the memory 118. The memory 118 may include, but is not limited to, computer-readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random-access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the software 116 or the memory 118. The functions, acts or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal so that a device connected to a network can communicate voice, video, audio, images or any other data over a network. The user interface 114 may be used to provide instructions over the network via a communication port. The communication port may be created in software or may be a physical connection in hardware. The communication port may be configured to connect with a network, external media, display, or any other components in system 100 or combinations thereof. The connection with the network may be a physical connection, such as a wired Ethernet connection or may be established wirelessly, as discussed below. Likewise, the connections with other components of the system 100 may be physical connections or may be established wirelessly.

Any of the components in the system 100 may be coupled with one another through a (computer) network, including but not limited to one or more network(s) 104. For example, the network manager 112 may be coupled with the devices in the network 104 through a network or the network manager 112 may be a part of the network 104. Accordingly, any of the components in the system 100 may include communication ports configured to connect with a network. The network or networks that may connect any of the components in the system 100 to enable data communication between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed, including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

The network manager 112 may act as the operating system (OS) of the entire network 104. The network manager 112 provides automation for the users 102, including automated documentation, automated troubleshooting, automated change, and automated network defense. In one embodiment, users 102 may refer to network engineers who have a basic understanding of networking technologies, are skilled in operating a network via a device command line interface, and are able to interpret a CLI output. Users 102 may rely on the network managers 112 for controlling the network 104, such as with network intent analysis functionality or for adaptive monitoring automation. The network manager 112 may utilize information stored in a database 110.

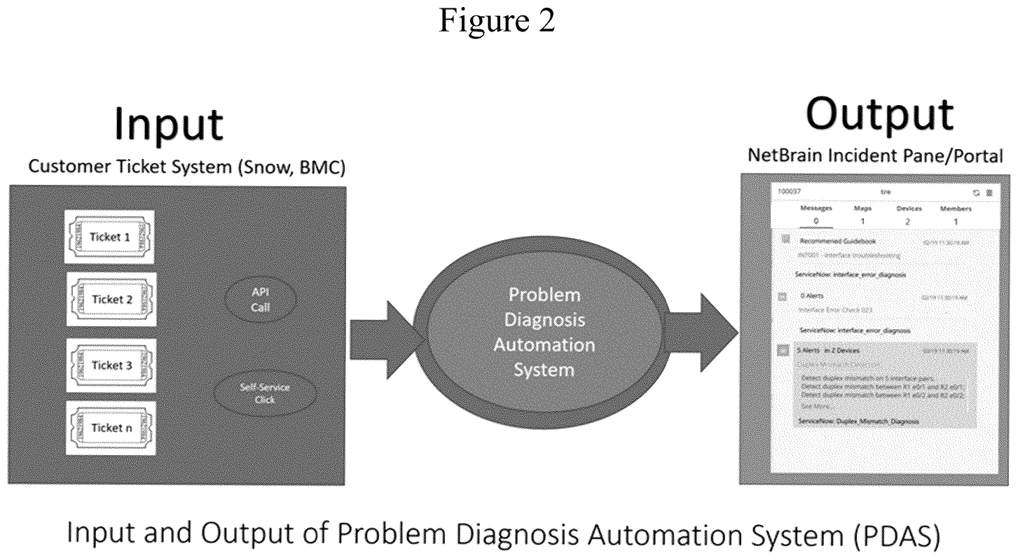

FIG. 2 illustrates the input and output of the Problem Diagnosis Automation System (PDAS). PDAS may include automating the Diagnosis of the repetitive problem and automating the enforcement of preventive measures across the entire network. PDAS automates the Diagnosis of repetitive problems and enforces preventive measures across the entire network. FIG. 2 shows, from the end user's perspective, the output of PDAs is an Incident Pane/Portal, a central collaboration platform for troubleshooting and data sharing for each problem. The input is various tickets provided by customers indicating a network problem/issue. The Network Manager 112 from FIG. 1 may be the PDAS system.

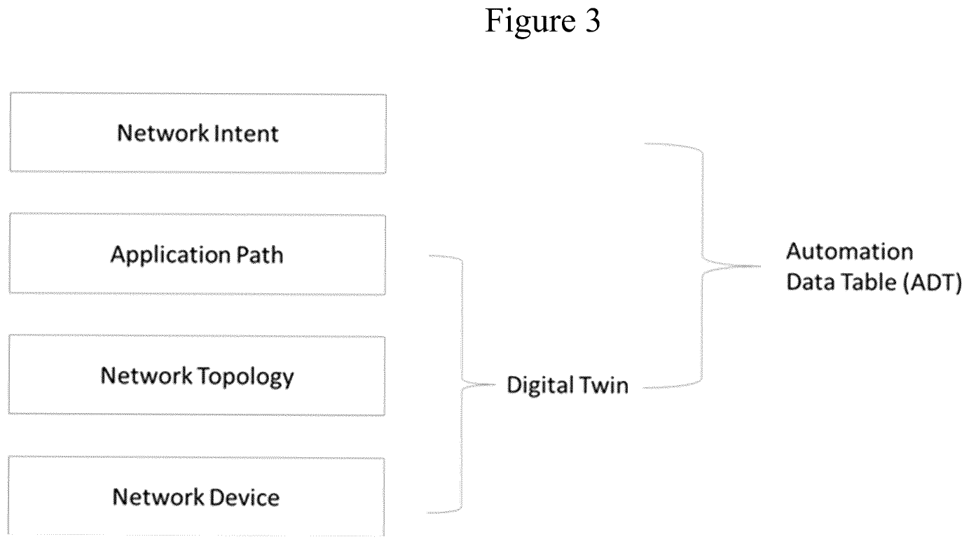

FIG. 3 illustrates a system organization with an Automation Data Table (ADT). The system may include a network automation platform designed to automate any network management task. The system discovers the whole network and builds a mathematic data model (“digital twin”) to mirror the network. The model is automatically updated by the scheduled discovery and benchmark tasks. The digital twin may include the network device data, the topology, and the application path. Above the digital twin, users can build the Network Intent (NI), which represents a network design and baseline configuration for that network or network devices with the ability to diagnose deviation from the baseline configuration. The NI can be replicated through the whole network. For example, see U.S. application Ser. No. 18/540,292, filed Dec. 14, 2023, entitled INTENT BASED AUTOMATION SYSTEM.

After NI is replicated to the whole network, a large network can have a large amount of intents. The Automation Data Table (ADT) can manage and use these intents efficiently. An ADT is a global data table for managing the critical network assets and network intents associated with those network assets. ADT may be a database for intents, supporting intent creation and replication, and can be used as the base for the network assessment. In one embodiment, the database 110 from FIG. 1 may be or store the ADT.

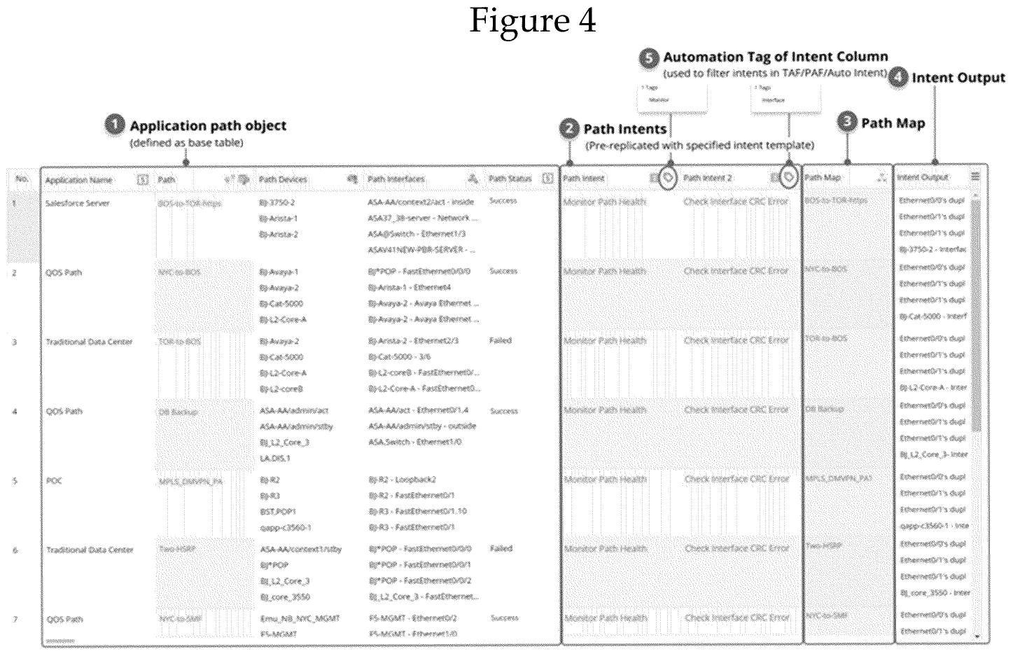

FIG. 4 illustrates an example Automation Data Table (ADT). An Automation Data Table (ADT) is a global data table for managing the critical network assets and network intents associated with those network assets. FIG. 4 illustrates the Application path object as the base table. The path intents are pre-replicated with a specified intent template. A path map and intent output are also included in the ADT. There may be an automation tag of the intent column as well for filtering intents.

ADT provides users with at least two capabilities: 1) using the ADT to build, organize and share the critical assets, such as critical Application and Path, WAN Link, Device Failover, Subnet, and Route, then associate intents and diagnosis results for troubleshooting network problems; and 2) using the ADT as a database for intents, supporting intent creation and replication. The system provides methods (e.g., Base Table and Column Group) in a function for an Automation Data Table Builder to ensure that users can build the table data and create and bind the intent for each automation asset.

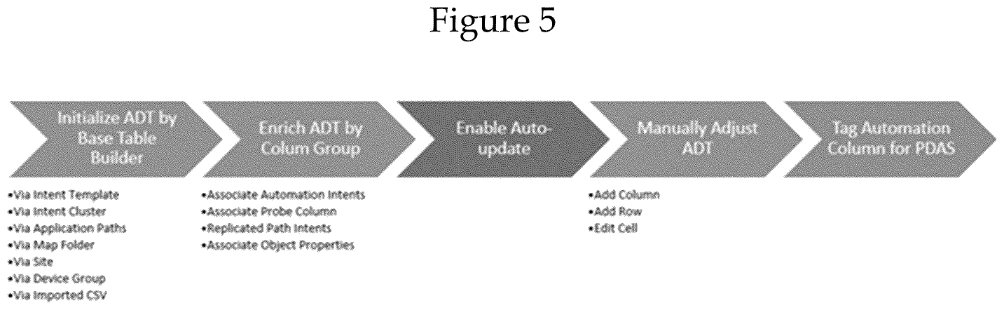

FIG. 5 illustrates an example creation of an Automation Data Table (ADT). The ADT is initialized by a base table builder, which may be through an intent template, intent cluster, application paths, map folder, site, device group, and/or imported database file (e.g., CSV file). The ADT can be enriched by a column group, such as associating automation intents, associating probe columns, replicating path intents, and/or associating object properties. The auto-update can be enabled and/or the ADT is manually adjusted through cell editing or adding rows/columns. There may be a tag automation column for filtering intents.

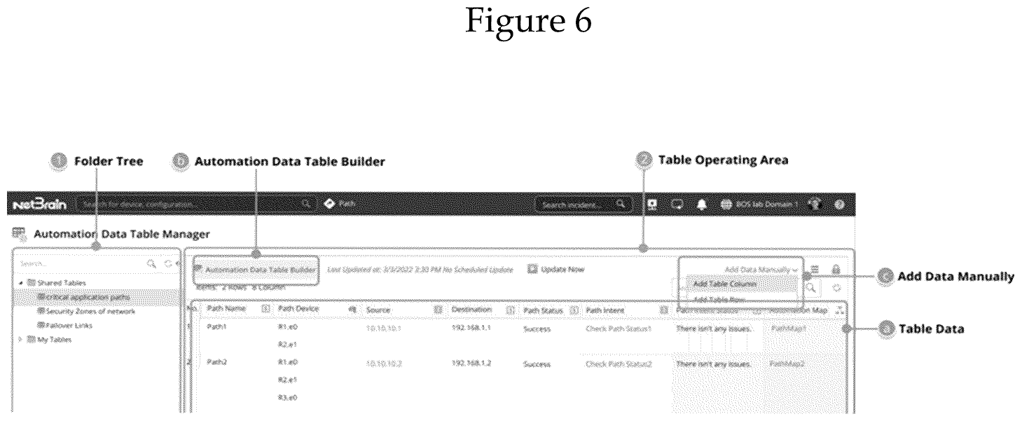

FIG. 6 illustrates an example management of an Automation Data Table (ADT). An Automation Data Table Manager is a centralized management interface of ADTs where end users can create, edit, and delete ADTs. It may include a folder tree or a table operating area.

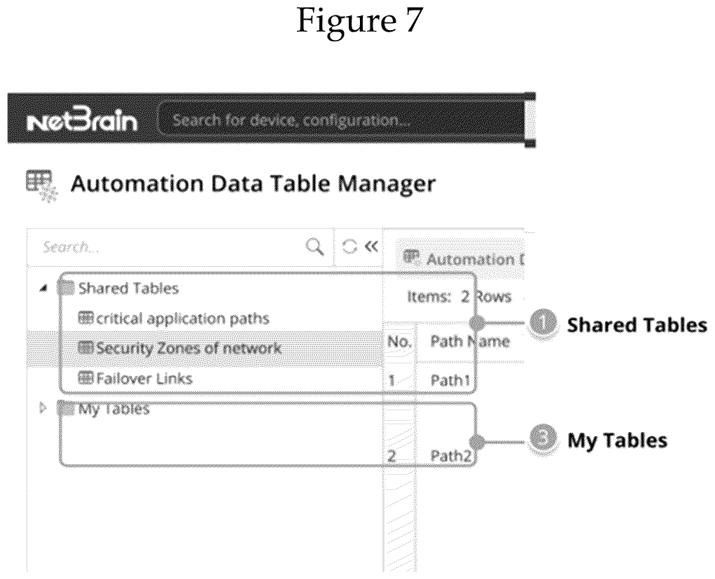

FIG. 7 illustrates an example Folder Tree structure. A Folder Tree structure can be used to organize shared tables and/or my tables (personalized tables). Referring back to FIG. 6, the Table Operating Area may be used to edit, clear and export data. For example, there may be Table Data for displaying the ADT data. There may be an Automation Data Table Builder for creating ADT.

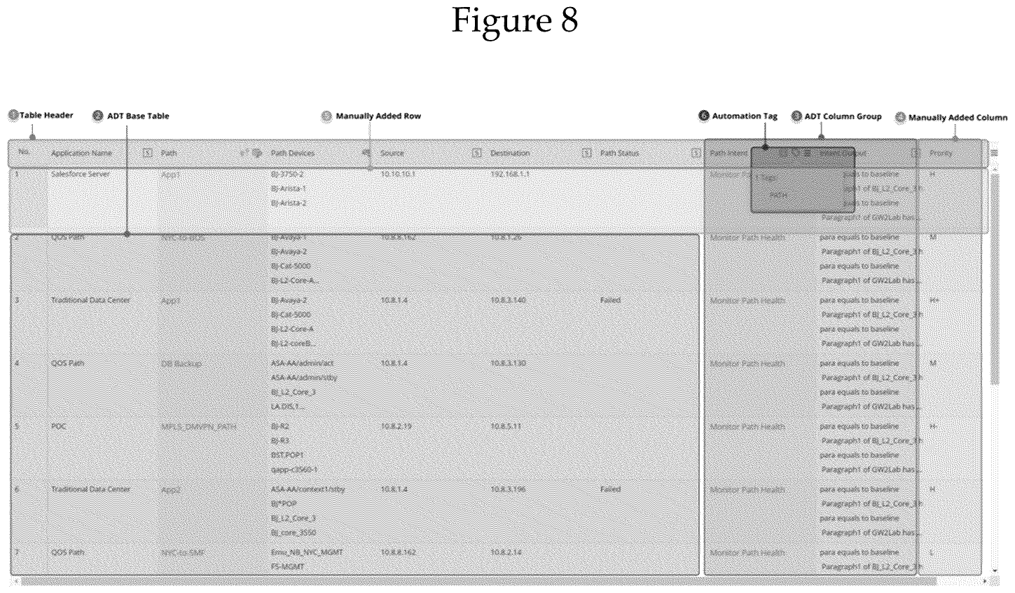

FIG. 8 illustrates an example of Table Data in an ADT. Table data may refer to the final table data of an ADT. This data may include: 1) Table Header; 2) ADT Base Table; or 3) ADT Column Group. The Table Header may include a display of the defined columns in the current ADT. Several operations on the column can be performed (e.g., Edit/Delete/Set as Table Key). The basic column information, such as the display name, column name and data type, may be displayed as a tip window. The ADT Base Table may include basic source data for building automation assets in ADT. A base table builder is one way of building basic data. As described below, there are many methods to create and populate the base table. The ADT Column Group includes columns added to ADT by Automation Data Table Builder to enrich the ADT data of automation columns. Column groups may depend on base table data and use the base table data as inputs. In one embodiment, there may be six methods to add a column group.

### Automation Data Table Builder

The Automation Data Table Builder may be an integrated user interface (UI) with capabilities for dynamically creating table data and dynamic columns. The Base Table Builder and Column Group Builder may be included here to ensure users can build the table data and create/bind the intent for each automation asset.

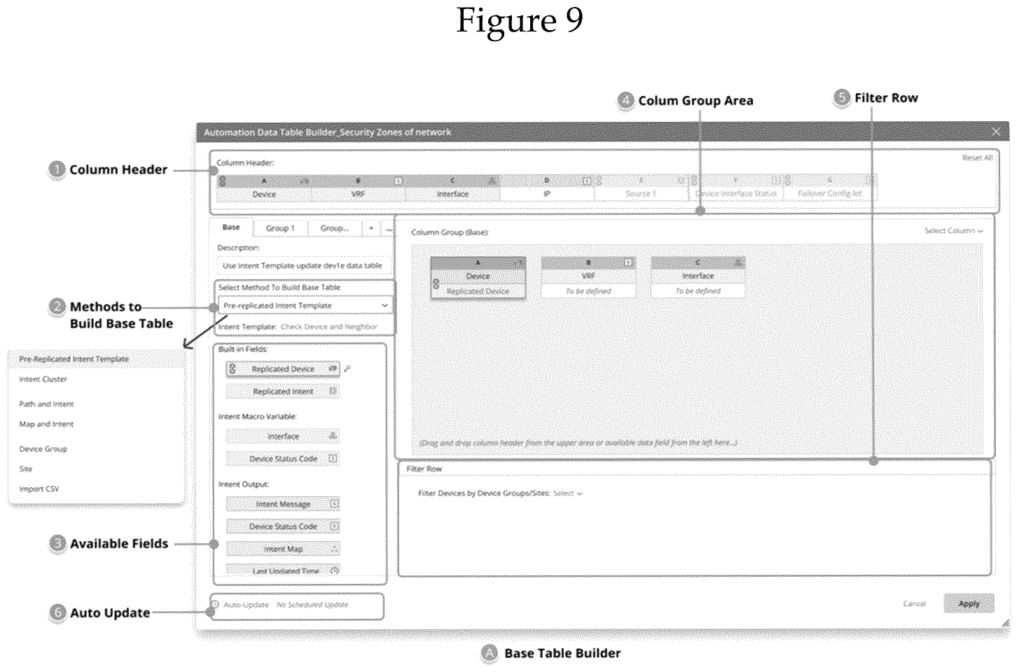

FIG. 9 illustrates a Base Table Builder. The Base Table Builder may be used for creating a basic network table. In some embodiments, the system supports at least seven methods to populate automation (intent/probe/map) columns, facilitating enriching/updating the ADT contents as shown in Table 1:

TABLE 1
Methods to populate automation (intent/probe/map) columns for the Base Table
Builder.

| Method | Populated Columns | Populated Rows |
|---|---|---|
| Pre-replicated | Replicated Intent | 1 device and 1 replicated intent per row. |
| Intent Template | Replicated Device | Furthermore, the network attributes corresponding |
| | Macro Variable | to the device can be extended by macro variables. |
| | (Dynamic) | |
| | Intent Output * | |
| Intent Cluster | Member Intent Name | 1 member intent per row. |
| | Member Intent Devices | Furthermore, the attributes corresponding to the |
| | Signature Variables | automation asset can be added as row data. |
| | (Dynamic) | |
| | Intent Output | |
| Application | Application Name | 1 path per row. |
| Path | Path | Furthermore, the path properties can be added as |
| | Path Name | row data. |
| | Path Devices | |
| | Path hops (device | |
| | interfaces) | |
| | Path Map | |
| | Source | |
| | Destination | |
| | Path Status | |
| Map Folder | Map | 1 map and 1 map intent per row. |
| | Map Name | Furthermore, the map can be added as row data. |
| | Map Devices | |
| | Map Device Interfaces | |
| | Map Intent | |
| | Intent Output * | |
| Site | Site Name | 1 site device and 1 site map intent per row. |
| | Devices in Site | Furthermore, the site properties can be added as |
| | Site Map | row data. |
| | Site Map Intent | |
| | Intent Output * | |
| Devices of | Device Name | 1 device per row. |
| Device Group | Device Group Name | Furthermore, the device group name and properties |
| | Device Properties | can be added as row data. |
| | (Dynamic) | |
| Imported CSV | CSV Columns (Dynamic) | 1 CSV row per row. |

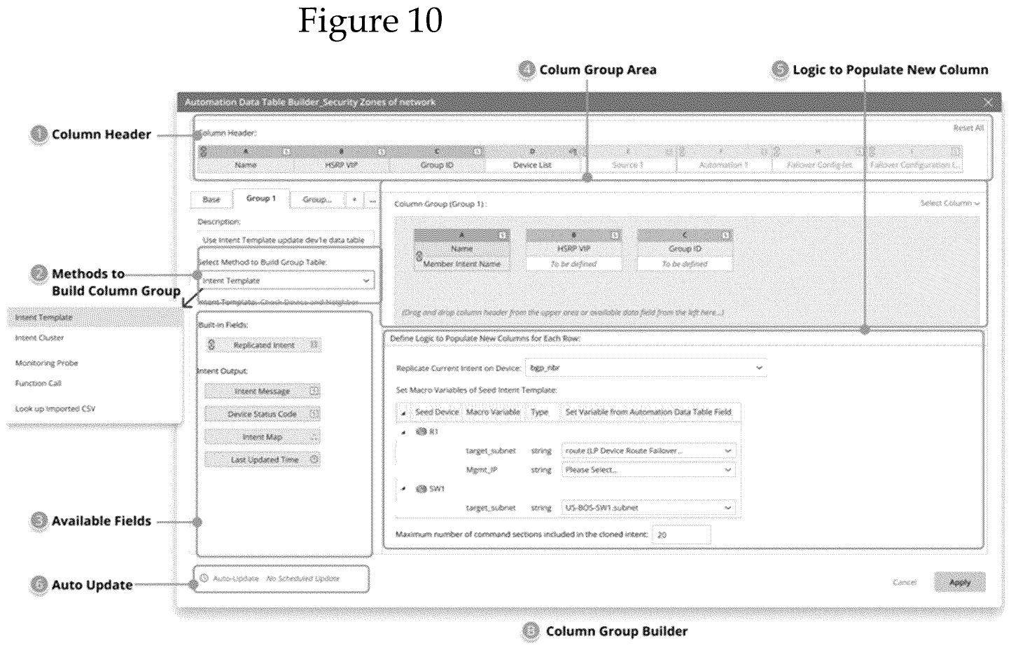

FIG. 10 illustrates a Column Group Builder. The Column Group Builder is used for creating dynamic automation columns or property columns for each automation asset. In some embodiments, the system provides at least five column group builders, as shown in Table 2:

TABLE 2
Methods for the Column Group Builder.

| | Populate Column | |
|---|---|---|
| Method | Data | Logic |
| Intent Template | Cloned Intent for | Clone intent for each valid row based on the defined device |
| | each Row | column. Add an intent column, then add the intent outputs |
| | | to additional columns. |
| Intent Cluster | Member Intent | Select a NIC, then match and filter a member intent for |
| | | each valid row and add the intent outputs to additional |
| | | columns. |
| Monitoring Probe | Probe | Filter probes by the probe name using the current ADT |
| | | data. |
| Imported CSV | CSV Column | Use selected key columns to match the rows in CSV files |
| | | and append specified columns from CSV files to the ADT |
| | | for new columns in the matched rows. |
| Function Call | Column's properties | Specify a column with the type of device and use device |
| | Covert source | properties and functions (e.g., transferring an IP address to |
| | column by function | a hostname) to fill in additional columns. |

### Automatic ADT Creation

In some embodiments, the ADT may be created automatically. Examples are described below utilizing the Automation Data Table Builder.

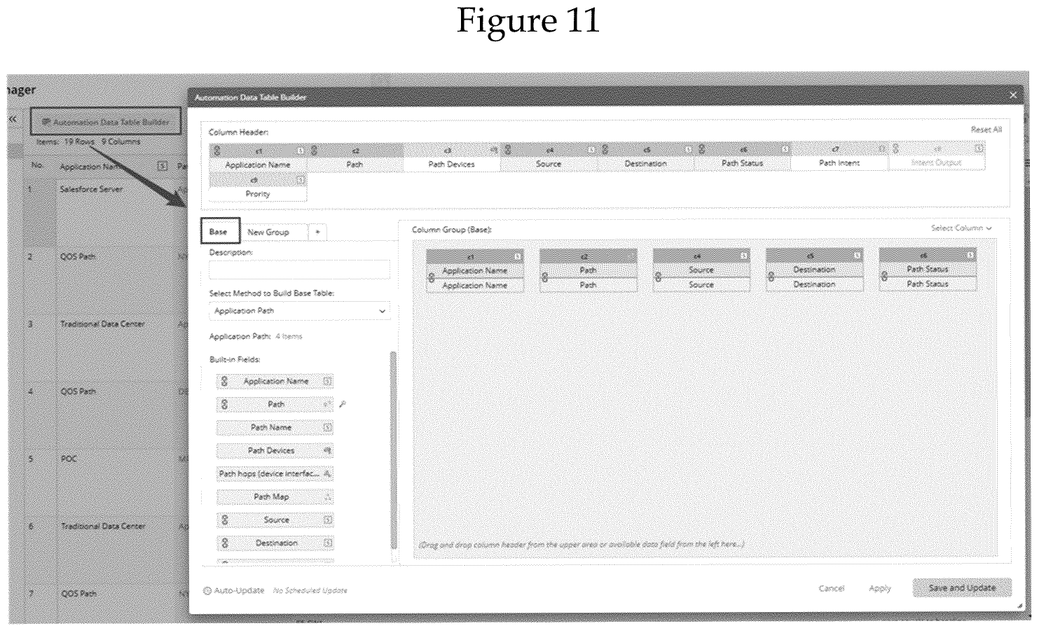

FIG. 11 illustrates an interface for building a base table in an Automation Data Table Builder. Specifically, a selection of Automation Data Table Builder>Base may be used to build a base table including data fields to include automation asset data to be used.

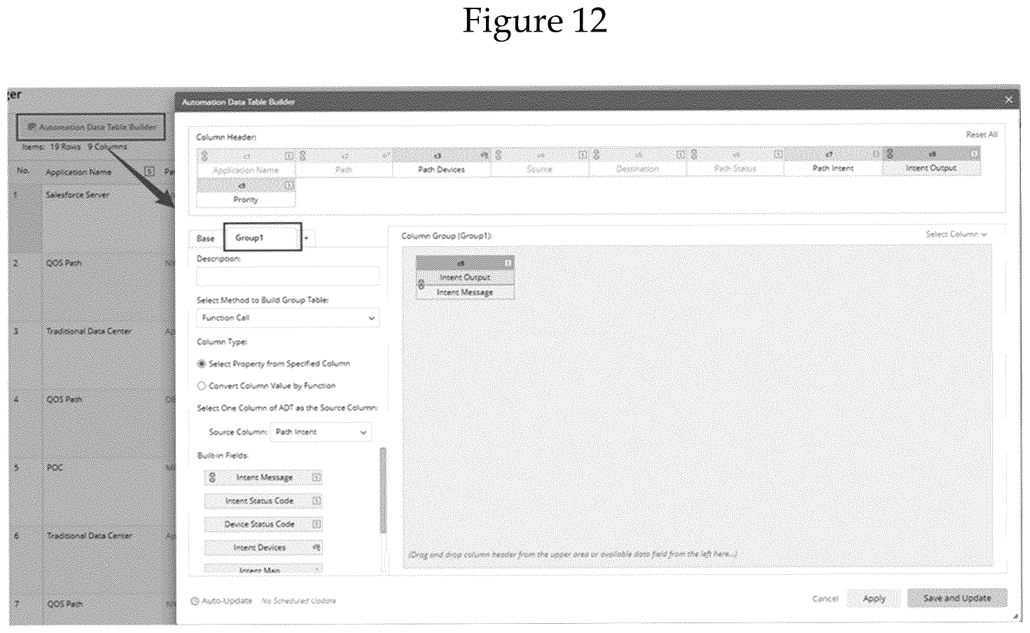

FIG. 12 illustrates an interface for building a column group tab in an Automation Data Table Builder. Specifically, a selection of Automation Data Table Builder>Column Group may be used to create column groups to enrich the base table data.

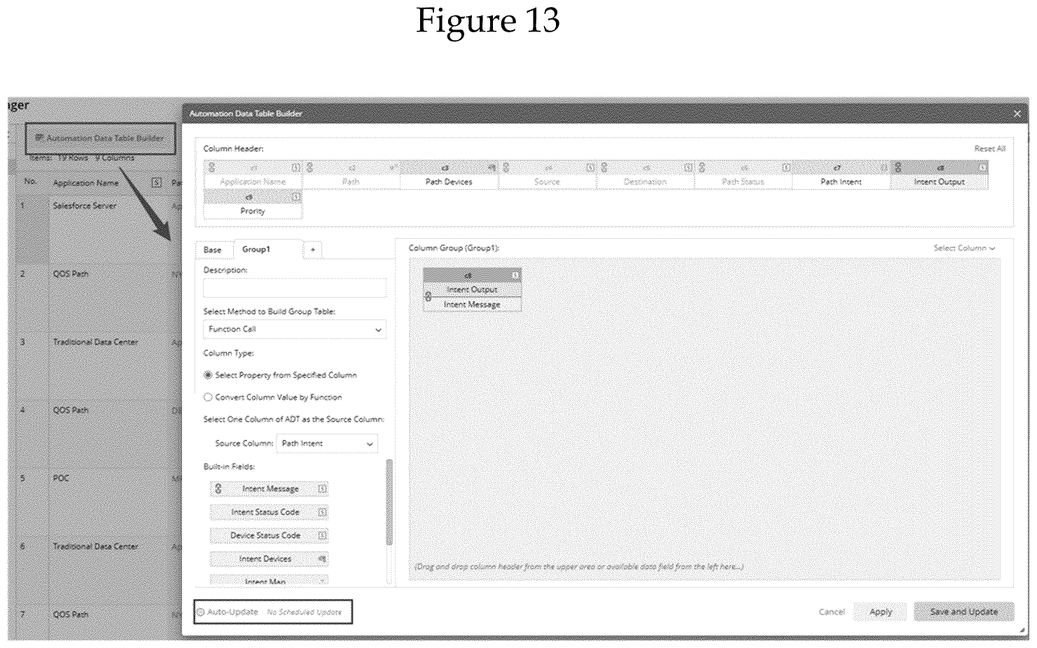

FIG. 13 illustrates an interface for updating a schedule in an Automation Data Table Builder. Specifically, a selection of Automation Data Table Builder (Schedule Update) may be used to schedule updating ADT data periodically.

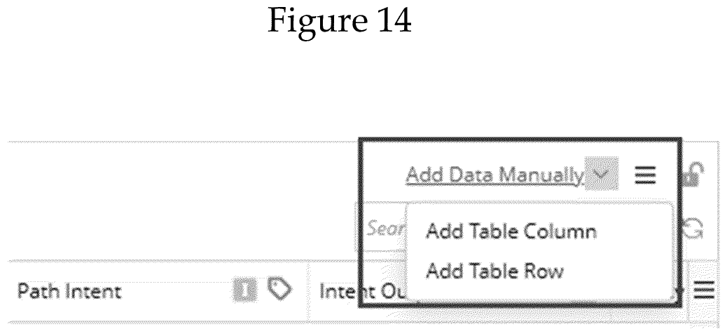

FIG. 14 illustrates an interface for adding data manually in an Automation Data Table Builder. Specifically, a selection of Automation Data Table Manager (Add Data Manually) may be used to manually add or adjust the table data.

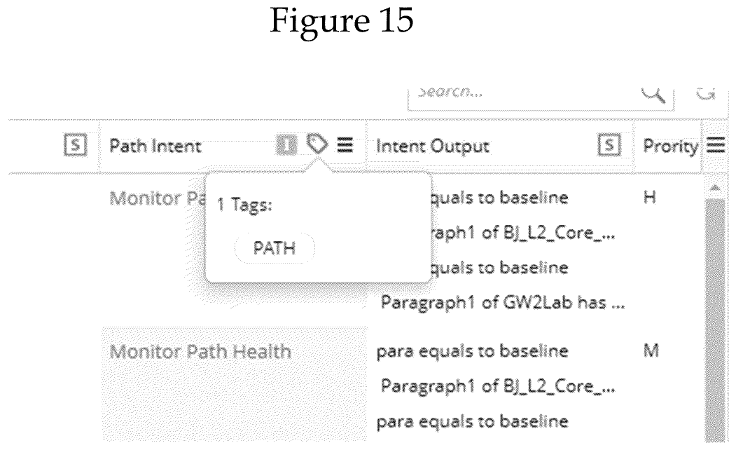

FIG. 15 illustrates an interface for creating tags in an Automation Data Table Builder. Users can select an existing tag for an ADT column or create a new tag. The tags can filter the intents used for TAF, PAF, Bot, Auto Intent or Follow-up Intent.

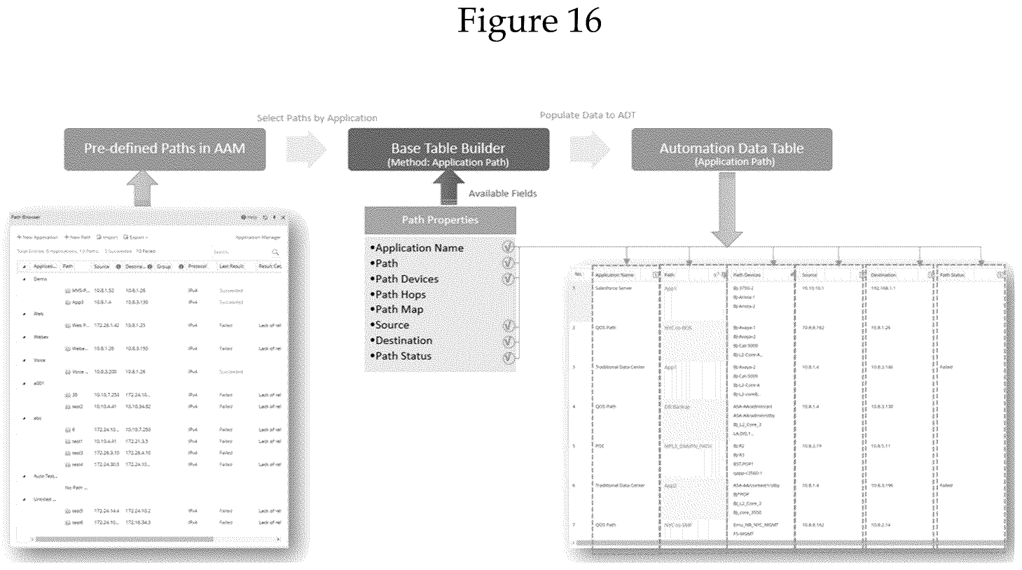

FIG. 16 illustrates a process for creating an ADT with an Automation Data Table Builder. In some embodiments, users can organize critical application paths and their automation intents into an ADT. This may include key path data (e.g., the source and destination IP address), then use the ADT to monitor the critical applications (e.g., PAF) and trouble any application-related issue (e.g., TAF/Chatbot/Auto Intent). The system may find the related paths for different types of events (e.g., a device interface has errors, the device configuration changes) by matching the ADT column data and the event information and executing the associated path intents for the problem diagnosis and change verification.

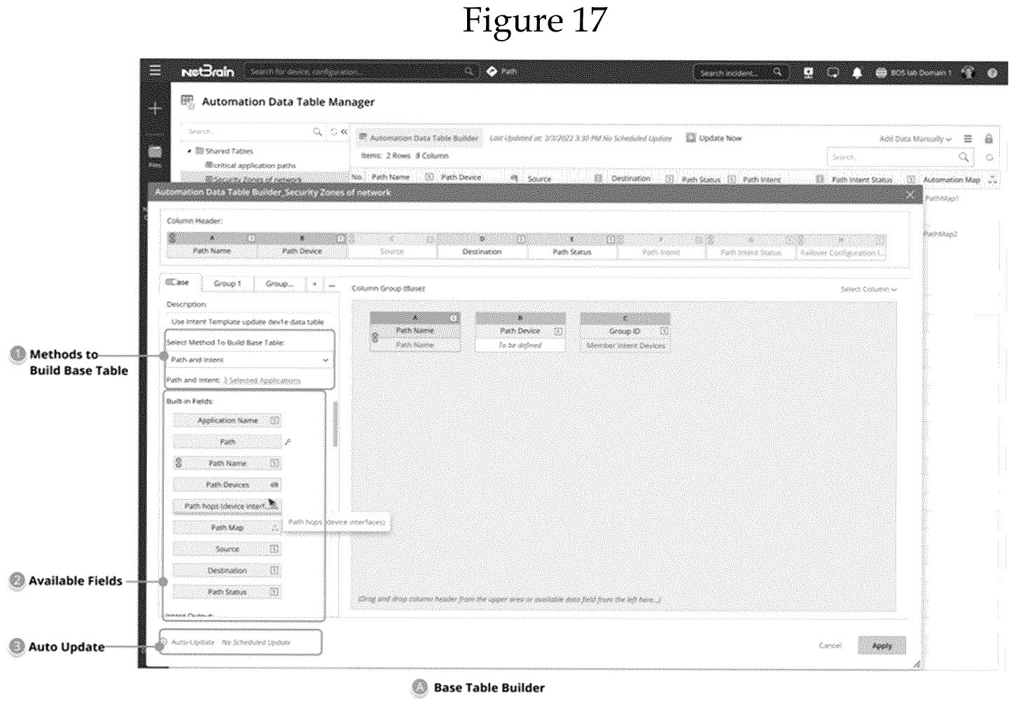

FIG. 17 illustrates an interface for using the Application Path for ADT building. Users can use the data from the Path Browser to build the base ADT table by using the Application Path method. Users can select paths from the Path Browser. There may be a mapping of available fields to the column group by dragging and dropping the available fields to the column group definition area to create ADT columns automatically. Selected fields may be from the following field categories in this area. For example, there may be built-in fields that are available for this base table that are listed as shown in Table 3. Applicable fields may include application, path (the link to this path), path name, other path properties, and path intent.

TABLE 3
Built-in fields for the Automation Data Table Builder.

| Field Type | Fields | Description |
|---|---|---|
| Built-in Field | Application Name | The built-in fields are created from path |
| | Path | properties. |
| | Path Name | |
| | Path Devices | |
| | Path hops (device | |
| | interfaces) | |
| | Path Map | |
| | Source | |
| | Destination | |
| | Path Status | |

After the ADT is created in Automation Data Table Builder, users can enable the Auto-Update for this ADT to update the data periodically.

The basic table data can be enriched with column groups. For a base table created via the application path, column groups can be added to cover more data. The system supports several methods to populate dynamic columns for a path-based table, as shown in Table 4.

TABLE 4
Methods to populate dynamic columns for a path-based table.

| Method | When needed? | Use Case |
|---|---|---|
| Use Intent | Add some additional intent | Intent Template (on-demand replication and Auto- |
| Template | columns for an ADT. | Replicated) is selected and used. Users add an intent |
| | | column (mandatory), and then the intent outputs to |
| | | additional columns. |
| Use Intent | Add some additional intent | Match and filter a member intent for each valid row and |
| Cluster | columns for an ADT. | add the intent outputs to additional columns. |
| Use Auto- | Add some additional probe | Filter a probe by the name using the current ADT data. |
| Probe | columns for an ADT. | |
| Use CSV | Have a pre-generated CSV | Use selected key columns to match the rows in CSV files |
| File | file and want to enrich | and append specified columns from CSV files to the |
| | table data with it. | ADT for new columns in the matched rows. |
| Use Function | Enrich ADT with some | Specify a column with the type of device and use device |
| | key column properties. | properties and functions to fill in additional columns. |
| Intent | Generate some suitable | See training documentation of Intent Replication for Path |
| Replication | path intent for application | for more information. |
| for Path | paths. | |

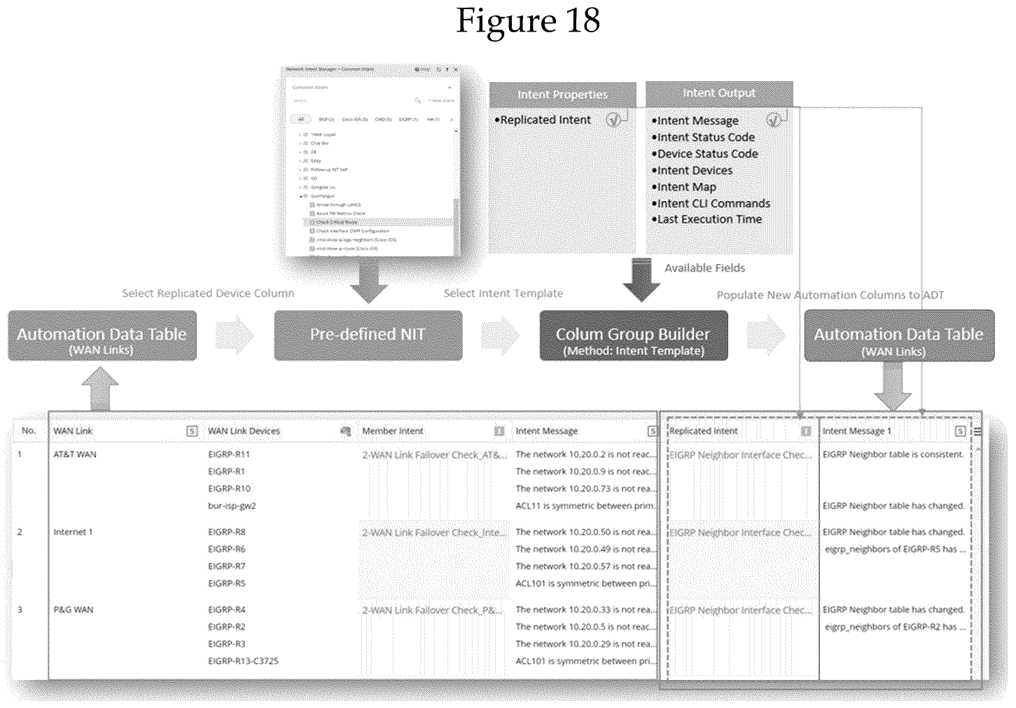

FIG. 18 illustrates how the intent template works in Column Group Builder. An automation column may be added from an intent template. Based on the base data of ADT, the intent template in the automation column may be used to replicate one intent for each ADT row. This cloned intent includes the automation data in this ADT and the detailed information of the cloned intent, shown in intent output columns. Users can select a base table column including device information for replicating intents.

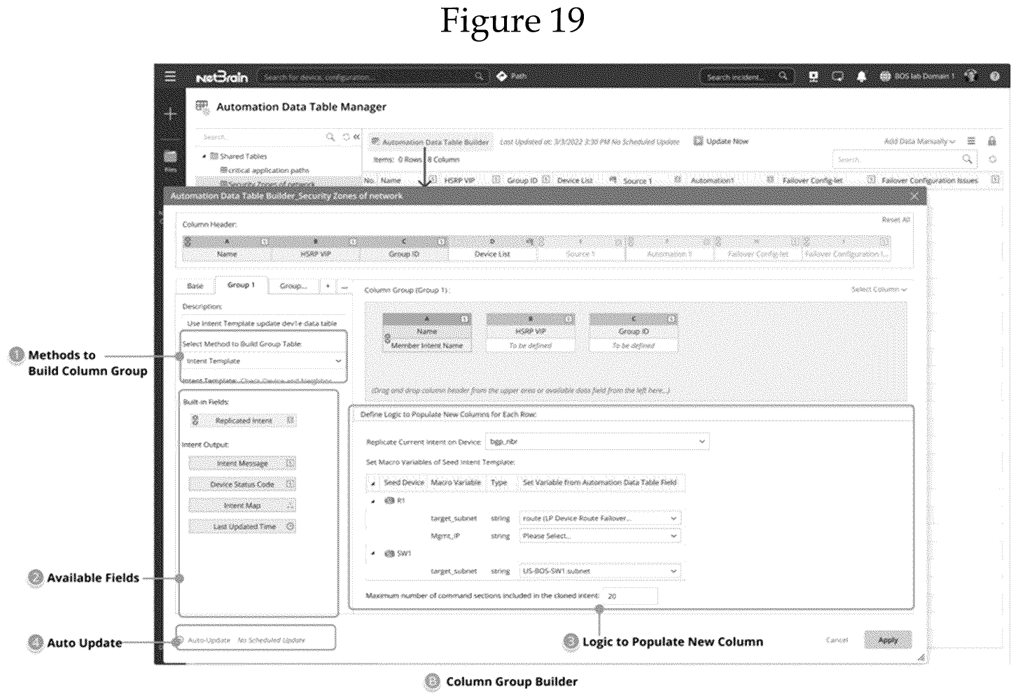

FIG. 19 illustrates an interface for the Column Group Builder when the Intent Template method is selected. The following table describes available fields for building a group table if the intent template is the data source:

TABLE 5
Available fields for building a group table if the intent template is the data source.

| Field Type | Fields | Description |
|---|---|---|
| Built-in | Replicated Intent | The built-in fields are created from the replicated intent |
| Field | | from the intent template. |
| Intent | Intent Message | The intent output fields are created from intent details of |
| Output Field | Intent Status Code | the intents generated from the intent template. |
| | Device Status Code | |
| | Intent Devices | |
| | Intent Map | |
| | Intent CLI Commands | |
| | Last Execution Time | |
| | CSV Columns | |

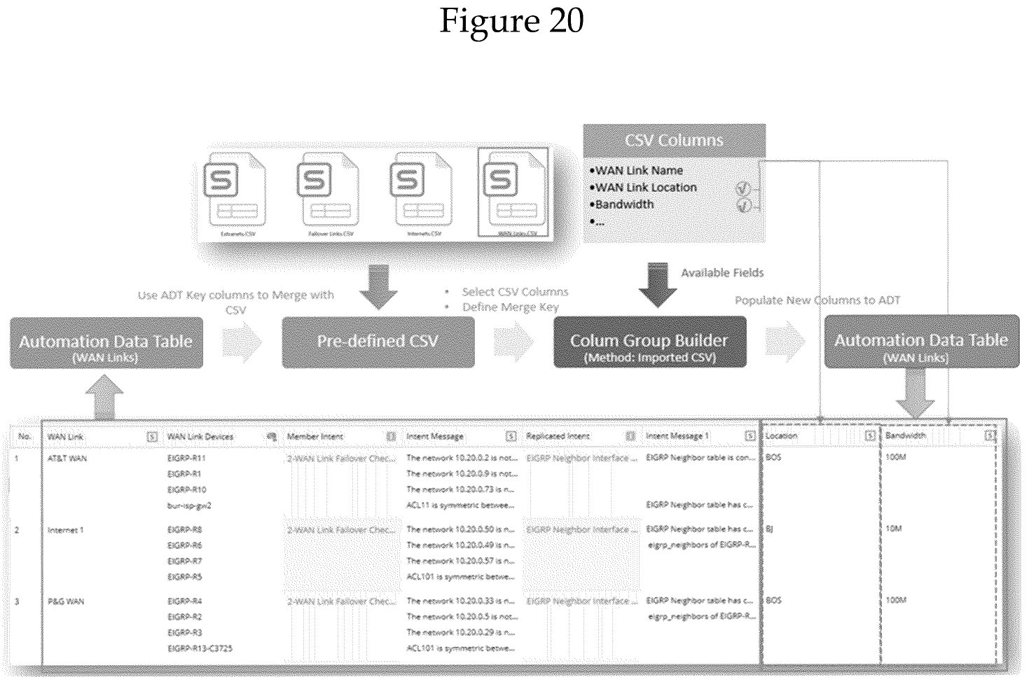

FIG. 20 illustrates a process for importing CSV in Column Group Builder. This may include adding an ADT column from the imported CSV. If users have local CSV files containing data, the CSV file can be imported to create an ADT group table. By default, all columns in the CSV may be added as available fields in ADT. To successfully merge the CSV columns to the base table, users may select fields from the CSV and fields in ADT as the table keys to be paired.

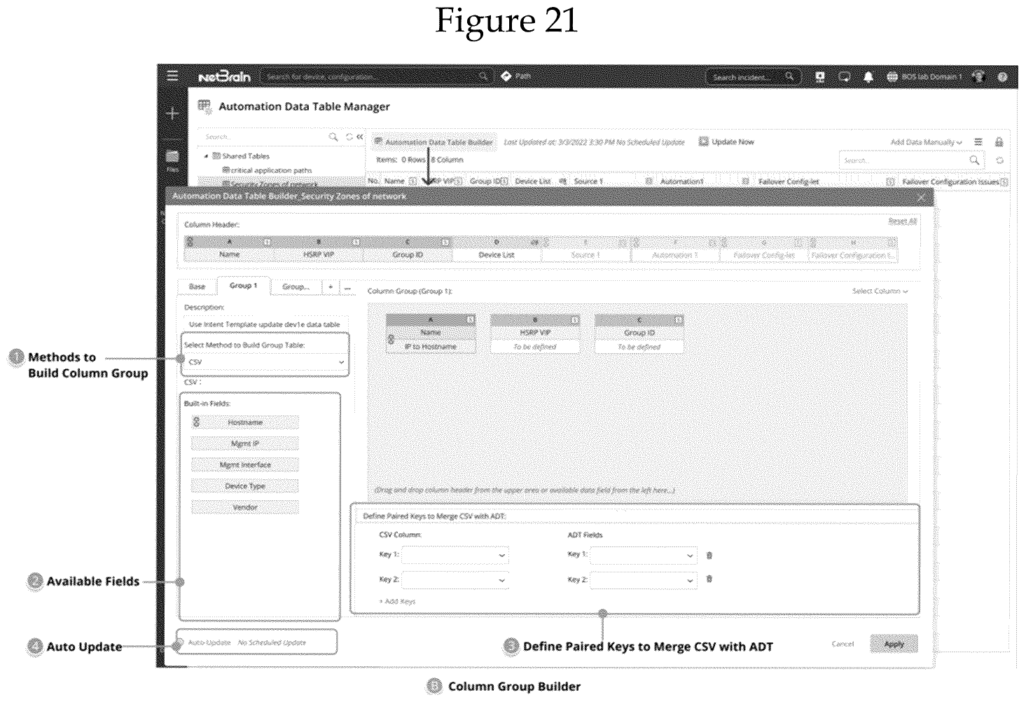

FIG. 21 illustrates an interface showing the importation of CSV in Column Group Builder. Specifically, FIG. 21 illustrates what the Column Group Builder interface looks like when the Imported CSV method is selected.

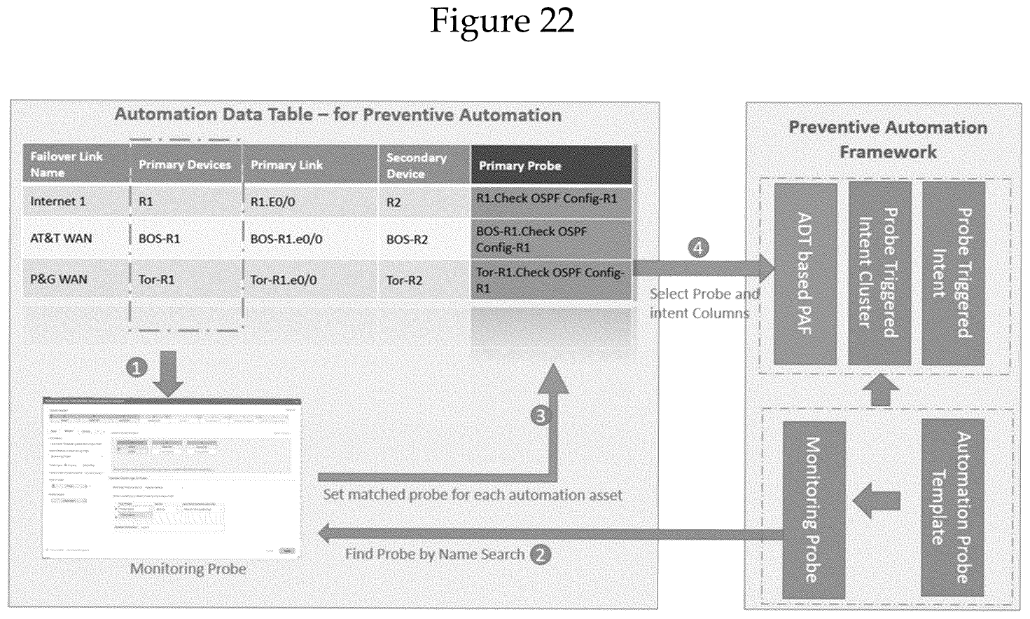

In some embodiments, a probe may be added into ADT for prevention automation. The probe installed for ADT may trigger the automation process associated with the ADT automation assets. FIG. 22 illustrates a probe triggering an automation process associated with the ADT automation assets. Specifically, this may include the corresponding PDAS flow. A probe column may be defined for using the primary and secondary probes to trigger automation with assets in the ADT. The probe properties may be used as the built-in data for the probe column. The flash alerts generated by the probes may also be the available data source.

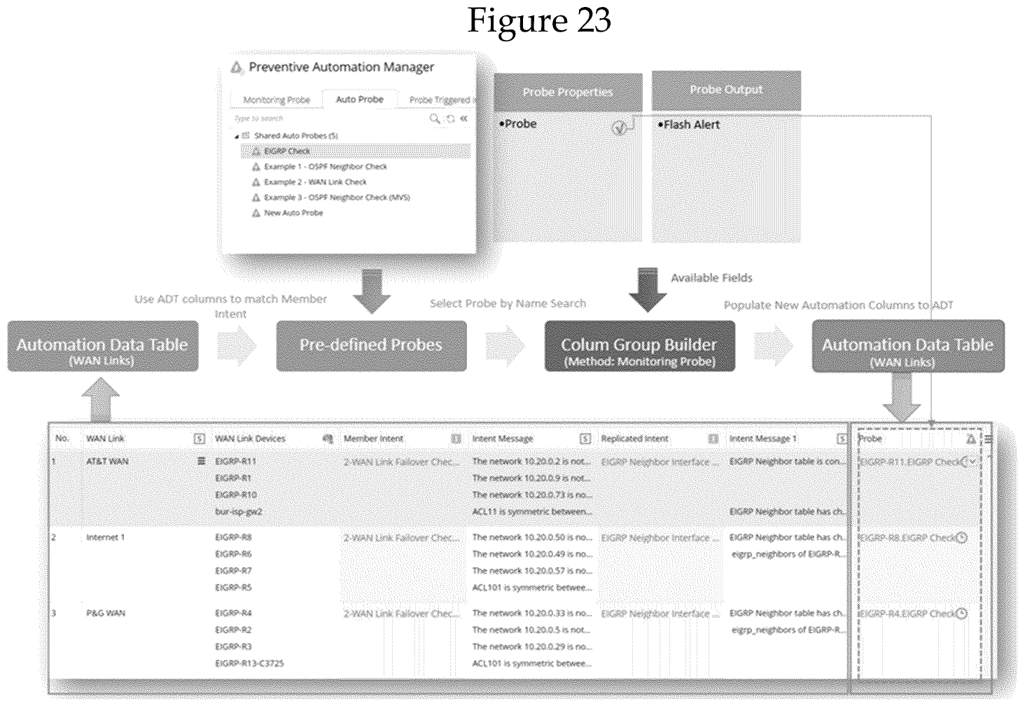

FIG. 23 illustrates a monitoring probe used in a Column Group Builder. Specifically, FIG. 23 illustrates what the Column Group Builder interface looks like when the Monitoring Probe method is selected.

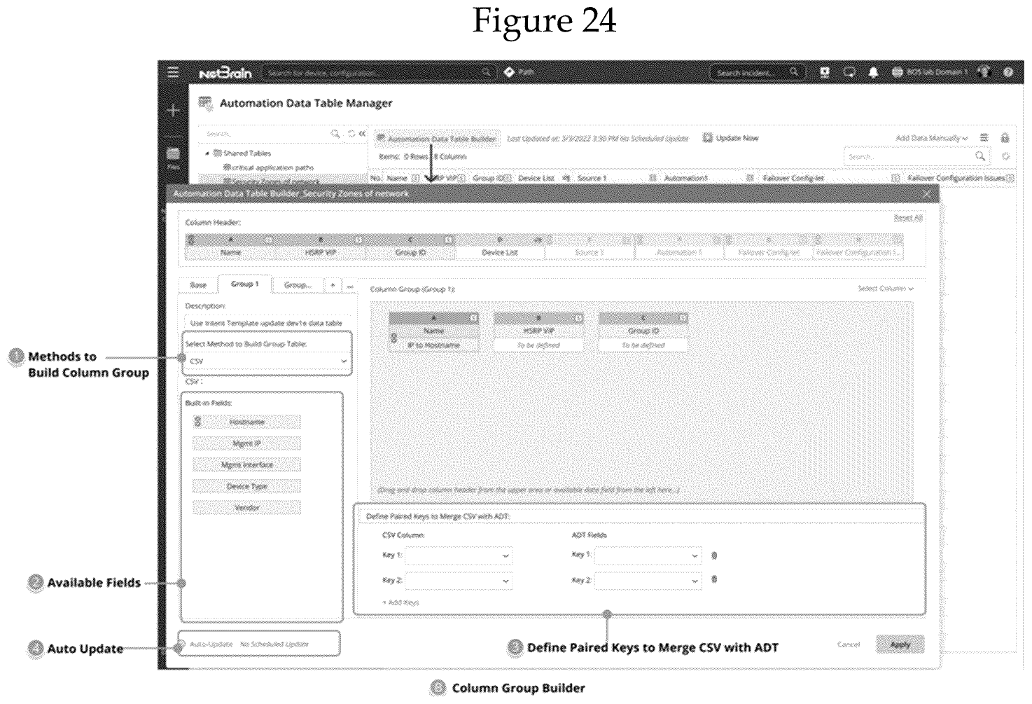

FIG. 24 illustrates the selection of a monitoring probe. The following table describes the data fields for building group columns via a monitoring probe:

TABLE 6
Data fields for building group columns via a monitoring probe.

| Field Type | Fields | Description |
|---|---|---|
| Built-in Field | Probe | The built-in field is the probe selected. |
| Output Field | Flash Alert | The Output Field is created by flash alerts generated |
| | | by the probes. |

In some embodiments, there may be a function for locking/unlocking ADT and ADT Editing Rights Control. To avoid misoperation on the ADT data, the ADT can be locked/unlocked by its creator or other users with privileges. In addition, editing rights may be introduced to the ADT feature to prevent data loss due to editing conflicts. For each ADT table, the creator or privileged user of ADT can switch on the locking function and set a locking mode (e.g., with a password or without a password). A locked ADT may be in View-Only mode and can be edited after entering the password. Lock annotation can be added to provide detailed lock information.

In some embodiments, there may be a function for editing rights control for ADT. The ADT may be edited by two or more users simultaneously, so in this example, one of the edited ADTs cannot be saved, causing data loss. To prevent such a problem, the user editing the ADT first owns the editing rights, and only the user with editing rights can edit the ADT. If a user without editing rights attempts to edit the ADT, a message will notify the user that the editing right is required.

In some embodiments, there may be a function for viewing the ADT execution log. The execution log is provided for an ADT to record the operations, such as replicating intents, matching intent, and the intent execution errors. Users can check and export the ADT execution log. There may be a time range to check the execution log for the period.

In some embodiments, there may be a function for an ADT audit log. The audit log may be provided to record and track the changes made to ADT to protect essential ADT assets. The ADT audit log may record the following operations:
Create ADT: Record relevant information when a new ADT is created.
Delete ADT: Record relevant information when an ADT is deleted.
Edit ADT: Record relevant information each time the ADT is edited.

In some embodiments, there may be a function for user privilege for ADT. ADTs may be organized in folders. There may be two privileges (Shared Resource and File Management and Private Resource Management privilege) that are associated with ADT. There may be an open ADT manager, which is a user having the Shared Resource and File Management privilege or Private Resource Management privilege can open the ADT manager. There may be an edit private ADT privilege that may require private resource management privilege to edit a private ADT. There may be a select ADT privilege, which may mean that no privilege is required for selecting an ADT, or there may be a use intent-based ADT that requires the privilege to edit intent to edit the ADT.

### ADT-Based Network Assessment

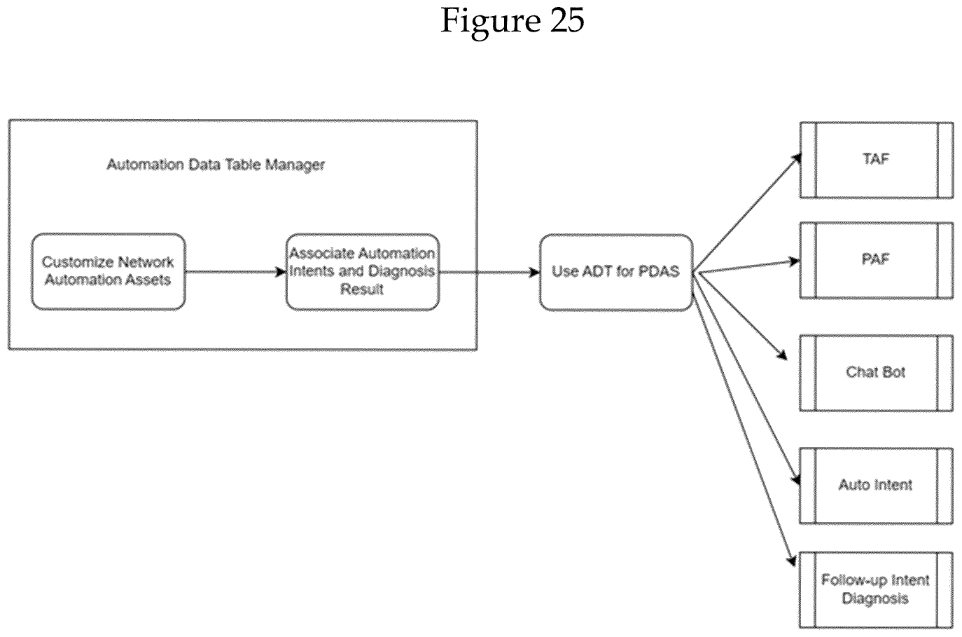

FIG. 25 illustrates ADT usage across different functions. As described, ADT may serve as a data reservoir for network management/automation. It may be used across functions (TAF, PAF, Auto Intent, Chat Bot, and follow-up Intent Diagnosis) to provide data for the proper operations.

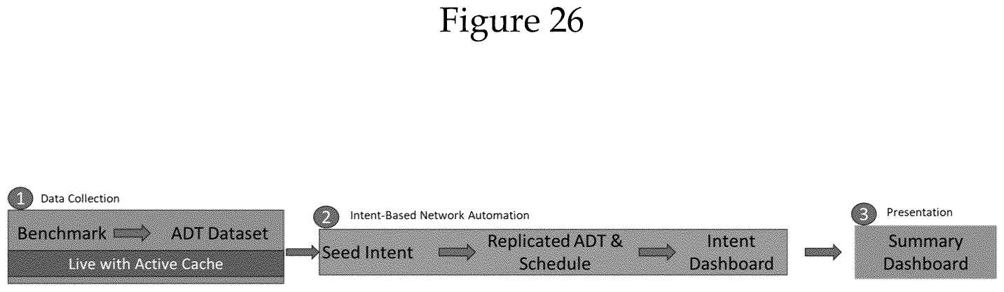

FIG. 26 illustrates network assessment with ADT. The ADT is a component of the continuous network assessment across an entire network or a subnetwork. The continuous assessment workflow may be in three steps: 1) Collect the data from the live network through a benchmark task and save the data in the ADT dataset, where the ADT dataset is used to decode, replicate and run intents; 2) Create ADT automations by replicating the seed intents, schedule running these intents, and create intent dashboards; and 3) The results of the continuous assessment are presented in a dashboard interface, such as a Summary Dashboard.

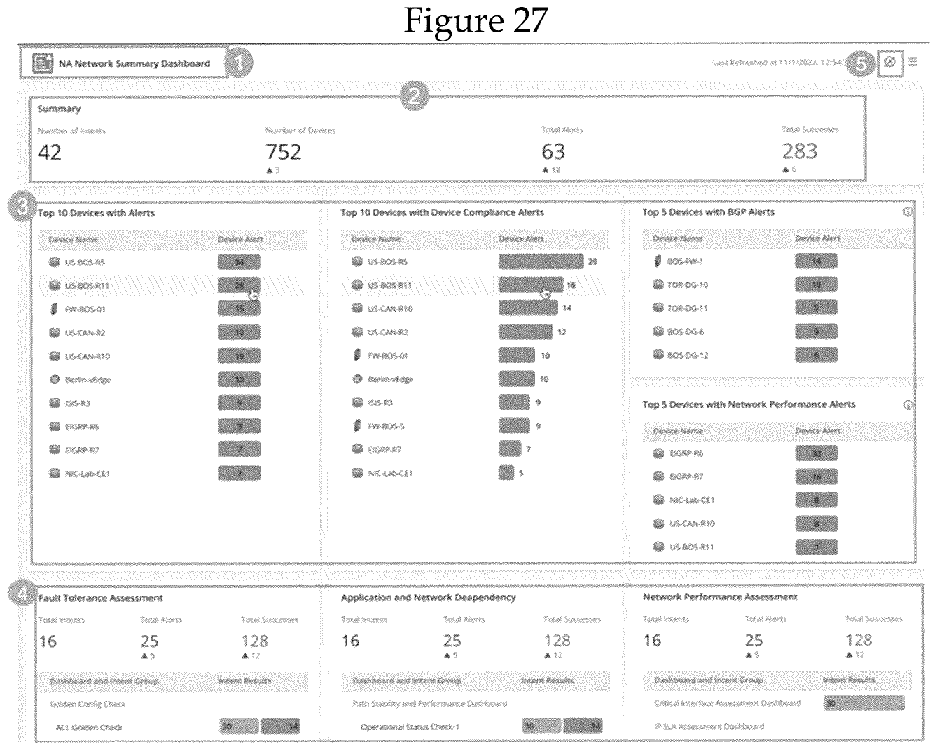

FIG. 27 illustrates an example Summary Dashboard, which displays the key metrics, the top devices with the most alerts, and the detail charts, with each row as an assessment point and each column as the alert counts for a device group or site.

For the creation of an ADT dataset in a continuous network assessment workflow, hundreds of assessment points across the large network may repetitively poll the same devices for the same data. It may be necessary to separate data collection from the assessment. A column group, the ADT dataset, can be used to store the device configurations and CLI command data. An ADT dataset can be repetitively used for building and debugging the intent base, even if network access is not available. The functions provided for creating, managing, or using ADT Dataset may include: 1) Build a dataset column group in ADT with four types of data sources (benchmarked data, imported data, manually retrieved data, and the updated by intent); 2) Build several dataset columns and tag them with one tag so that these dataset columns can be used together; 3) Use the ADT dataset as the data source for intent-based automation; and 4) Update benchmark commands and dataset by intent, enabling users to build the ADT dataset via running intent.

The system adds a method of building a column group, ADT Dataset, to add device configuration files and CLI commands as links into the dataset column, serving as the data source for intent creation, decoding, replication, and execution. The ADT dataset column group can be created by the following four types of data sources:

TABLE 7
Types of data sources.

| Data Source | Description |
|---|---|
| Benchmark | Use CLI commands from benchmark task results to create an ADT dataset |
| | column. |
| Imported Files | Import device configuration files and CLI command data from external |
| | files via Import File Wizard, then the imported data can be added to |
| | ADT. |
| Manually Retrieved | Manually add commands to the ADT dataset or select commands of the |
| Data | intents of an ADT. Then, these commands can be manually retrieved later. |

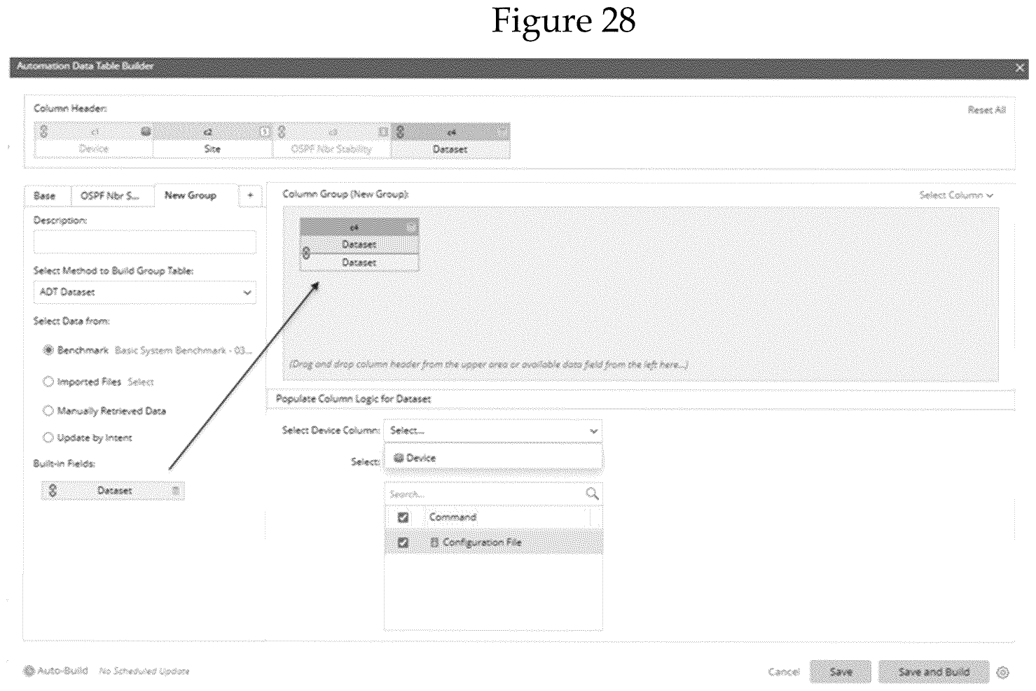

FIG. 28 illustrates an example interface for a benchmark task. The dataset may be created by a benchmark test. For example, commands from a benchmark task may be used to create an ADT dataset column. Users must select the device column, and the command data of the devices in the selected column will be added to the dataset. Users can select All Commands or Specify Commands to be added to the ADT dataset.

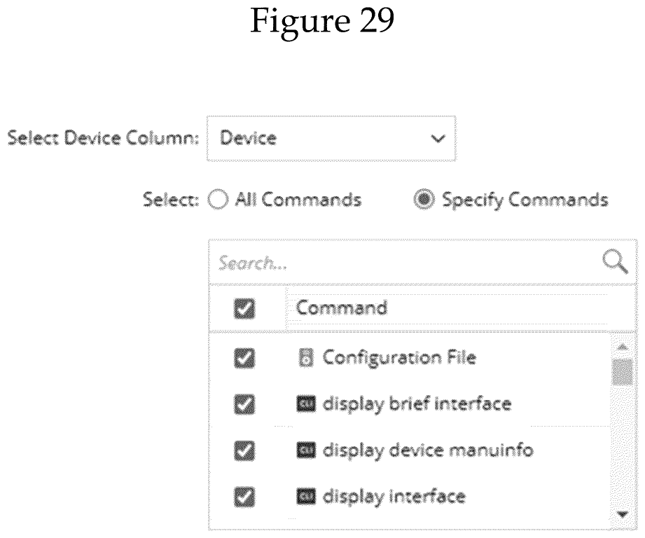

FIG. 29 illustrates example commands for the ADT dataset. The commands may include Configuration File, showing brief interface, displaying device manual information, or showing interface.

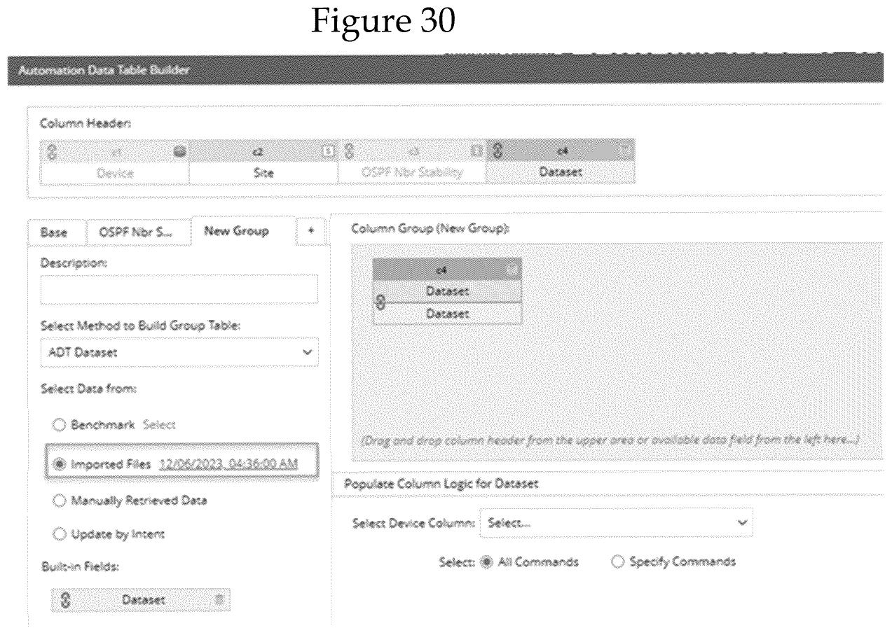

FIG. 30 illustrates an interface for importing files. A dataset may be created by importing files. Users can associate the imported data with an ADT dataset in an Import File Wizard or create a dataset from the imported files in ADT Builder. Users can select one or multiple imported dataset files. If only one dataset file is selected, the time of importing the dataset file is displayed next to the Imported Files option. Users may then select a device column and commands to be added to the dataset.

A dataset may be created by manually retrieving data. For example, a user may manually add commands to the ADT dataset. The system supports adding commands By Specific Devices and Commands and By Selected Intents.

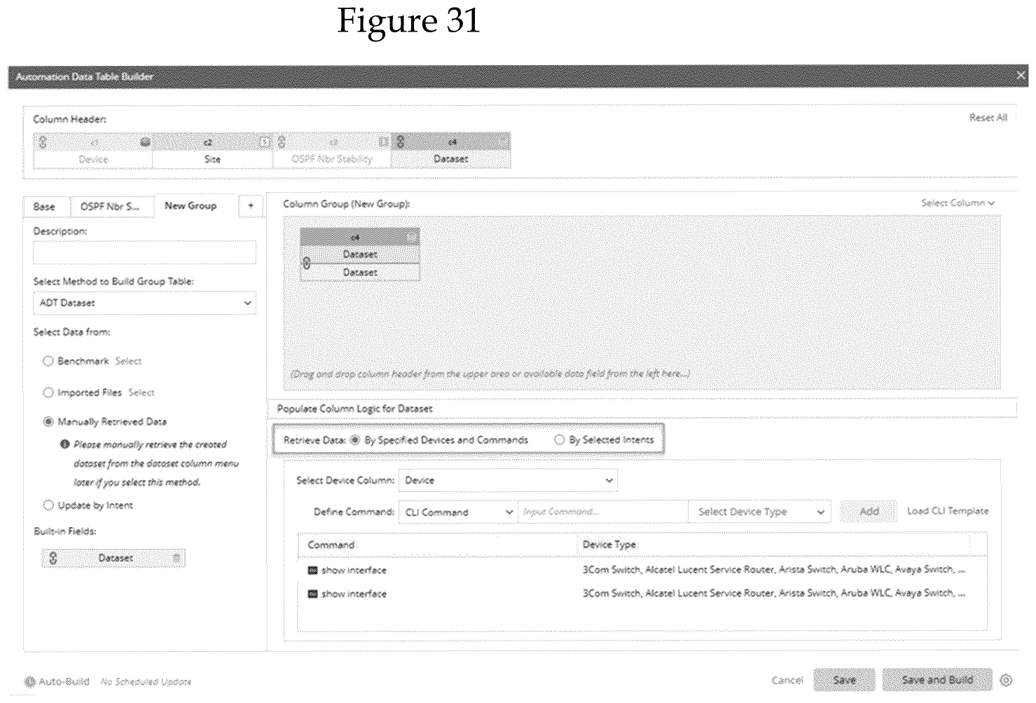

FIG. 31 illustrates an interface for adding commands to an ADT dataset. This addition may be by Specific Devices and Commands. The CLI commands and applicable device types are defined. During manual data retrieval, the command data will be obtained per device based on the corresponding device type. Commands can be added by the template or individually. Users can also select Configuration to automatically retrieve device configuration files without specifying the device type. The manually added commands may also be by selected intents. A user can select one intent column of ADT to automatically retrieve the device command data of the intents in the intent column from the live network.

A user can schedule the ADT execution with the Intent timer. For example, the intent timer may be once every day. Users can install the ADT with the trigger method via the Intent Timer. From the configuration window, the user selects the intent timer to trigger the selected intents.

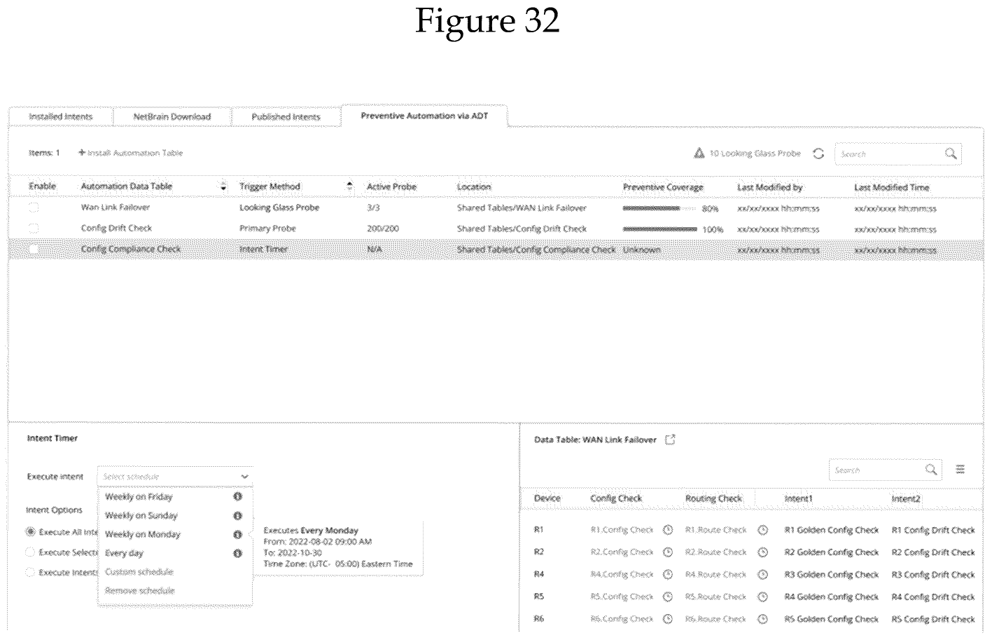

FIG. 32 illustrates an interface for scheduling execution with a trigger. Other methods to schedule run ADT can be done through the looking glass probe and Primary Probe (an example can be found in US Pat Pub. No. 2022/0360509 incorporated by reference herein).

### Intent and Summary Dashboard

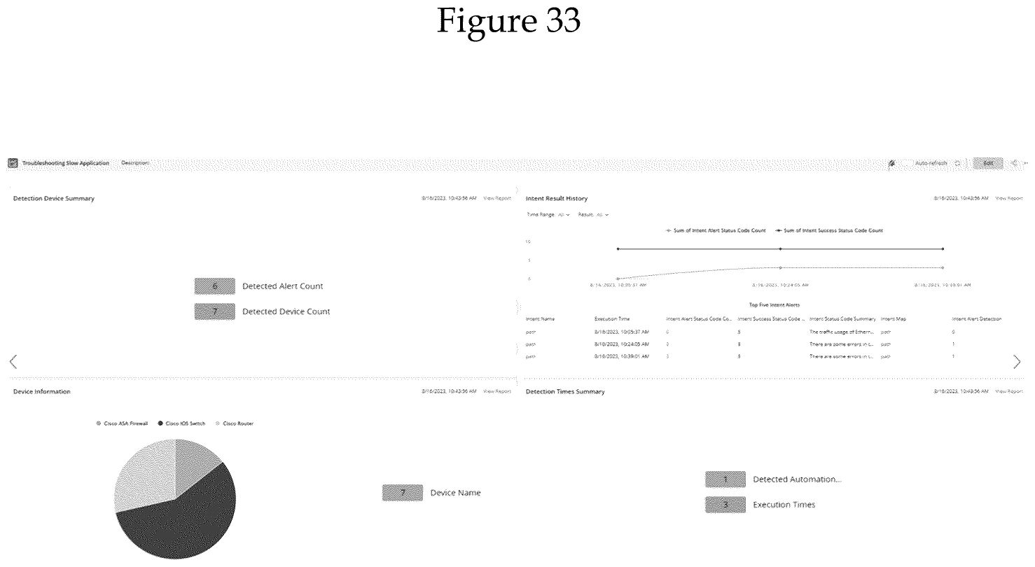

FIG. 33 illustrates an example Intent Dashboard. The intent results can be displayed in the Intent Dashboard. The Intent Dashboard can be created directly from a map or an Intent. For example, users can create an Intent to troubleshoot a slow application and then execute it every 15 minutes for one week. The Intent Dashboard may be created to display the results of each execution. The Intent Dashboard may be auto-refreshed to update the execution result of the intent and provide an alert notification by email.

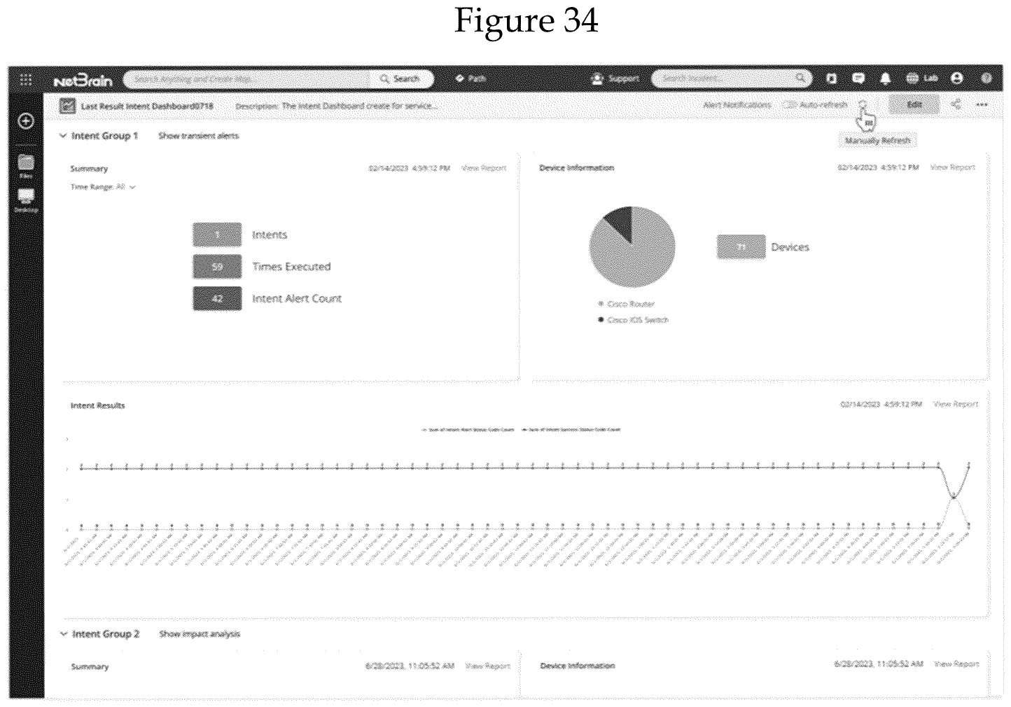

FIG. 34 illustrates example intent results on the Intent Dashboard. The purpose of the Intent Dashboard may include the display of the Intent results in the different types of charts. The Intent Dashboard may include intent sources and groups. The user can add many intents to a dashboard and put them into different intent groups. Each group may have its input resources (report). By default, all intents may be put into Group 1. Each group may include three charts: invent summary, device information, and intent results. The Intent Dashboard may include the intent summary chart that can display names, times executed, and intent alerts. The Intent Dashboard may further include device information. A device information chart may display the properties of intent devices, such as name, vendor/model, management IP, device intent status code, etc. The Intent Dashboard may include intent results. An intent result chart may display the historical or last intent results, the intent or device intent results. The data may be the success/alert status count. The time grain can be real-time, hourly, daily, weekly, or monthly. The Intent Dashboard may allow for auto or manual refreshing. The Intent Dashboard may include each chart with a customized style and callout. Likewise, each chart may have its filter, either by time range or by results (with or without alert). Further, each chart element may have its drill-down report and action. The Intent Dashboard may include alert notifications so that users can select whether to send alert notifications by email, which can be useful for troubleshooting transient problems and PAF.

Users can group all intent dashboards of the network assessment into a Summary Dashboard and display intent results by devices, sites, or device groups. Users may use the summary dashboard to monitor critical information across thousands of devices and discover the root cause for issues in one view. In the continuous assessment workflow, the Summary Dashboard may be used to present the assessment results, with each row as an assessment point and each column as the alert count for a device group or site.

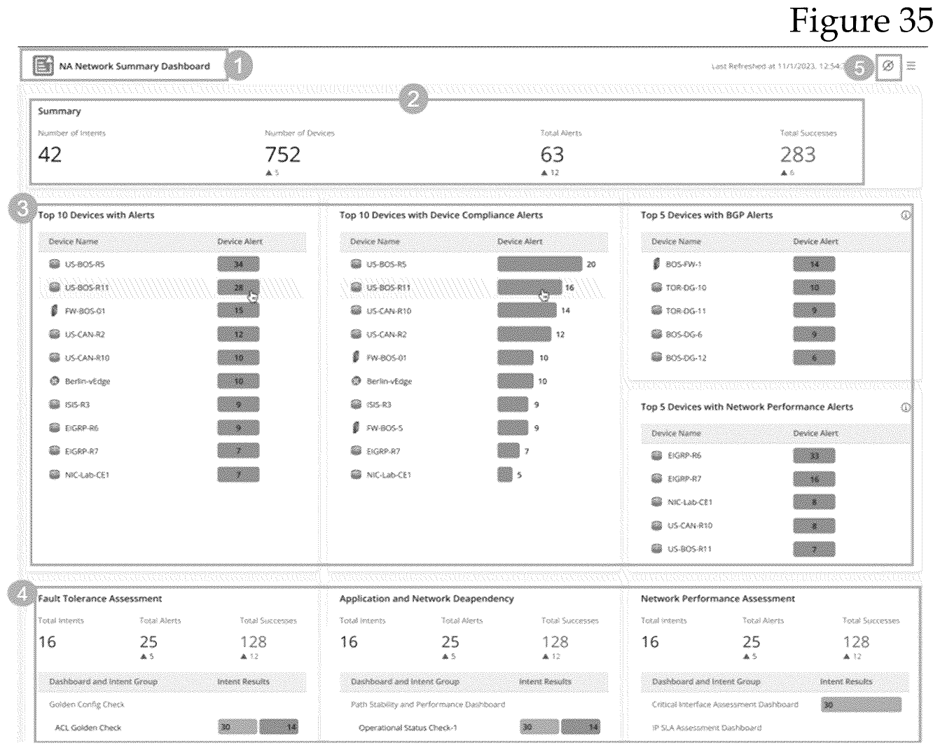

FIG. 35 illustrates an example view summary for the intent dashboard. The view summary dashboard page may include a Name and Description. The view summary dashboard page may include a Summary Chart, which summarizes the key metrics on this dashboard, including the number of intents, number of devices, total alerts, and total successes. The view summary dashboard page may include a Top-N Chart, which lists the devices with the most alerts in descending order for selected dashboard groups. The view summary dashboard page may include a Result Detail Chart, which displays detailed diagnosis results from various perspectives based on user settings. The view summary dashboard page may include Intent Results, which displays the number of intent successes and alert status code count for intent groups on selected dashboards. The view summary dashboard page may include Device Results, which displays the number of device successes and alert status code count for intent groups on selected dashboards. The chart further breaks down the device results by device, site, or device groups. The view summary dashboard page may include an auto-refresh where users can define a frequency for the summary dashboard to automatically refresh.

### ADT for PDAS

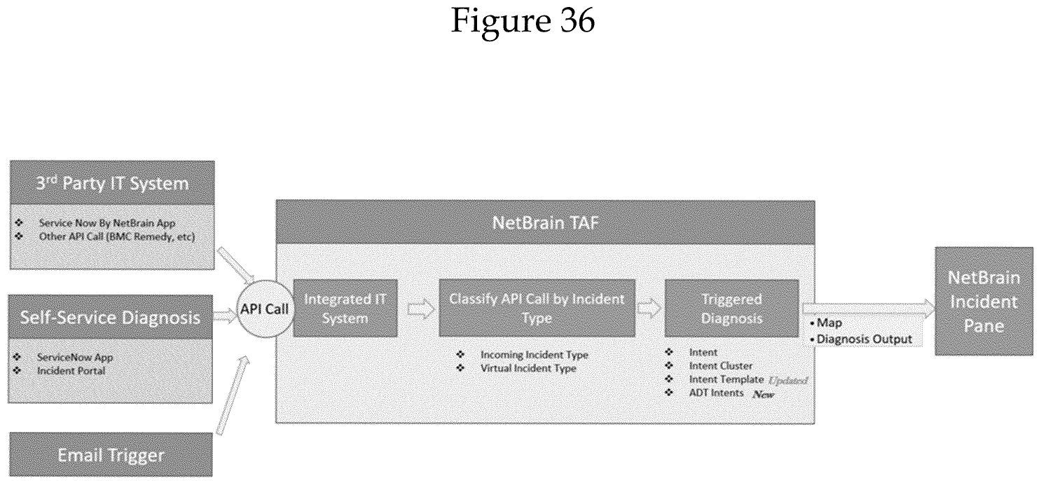

FIG. 36 illustrates an example process for installing ADT intents for TAF. ADT Intents may be installed for TAF. To analyze and solve the network issues of automation assets, the user may install Intents of ADT to TAF and trigger these intents by third-party events. There may be improved TAF Triggered Diagnosis to support ADT intents, a set of Intents associated with specific assets (e.g., application paths, critical failover links) in ADT. Another TAF enhancement may include supporting the assigning of values to Macro Variables in the intent template.

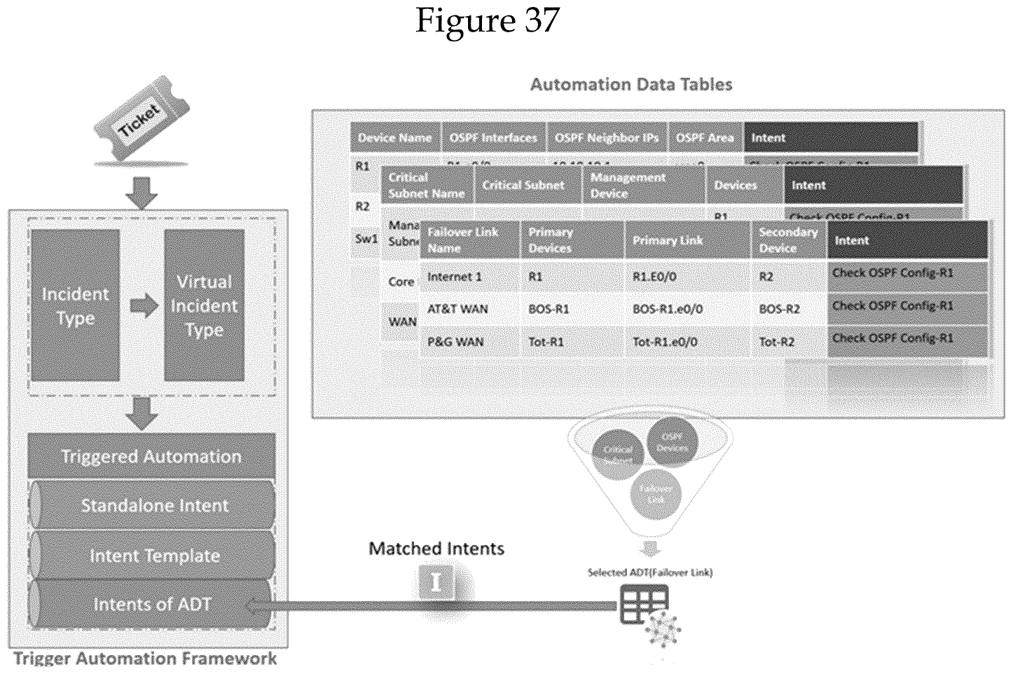

FIG. 37 illustrates an example triggering of diagnosis using ADT intents. Diagnosis may be triggered using ADT intents. For issues related to Automation Assets, the ADT intents may be triggered to troubleshoot issues related to automation assets, e.g., checking failover links and checking Critical Routes. To conveniently address and analyze the network issues of automation assets, users can install Intents of ADT to TAF and trigger these intents by events (e.g., tickets from a third party). ADT-based PDAS works in TAF with an initial ticket that triggers finding related network assets using the ADTs. The matched intents are identified and executed in response to the initial ticket.

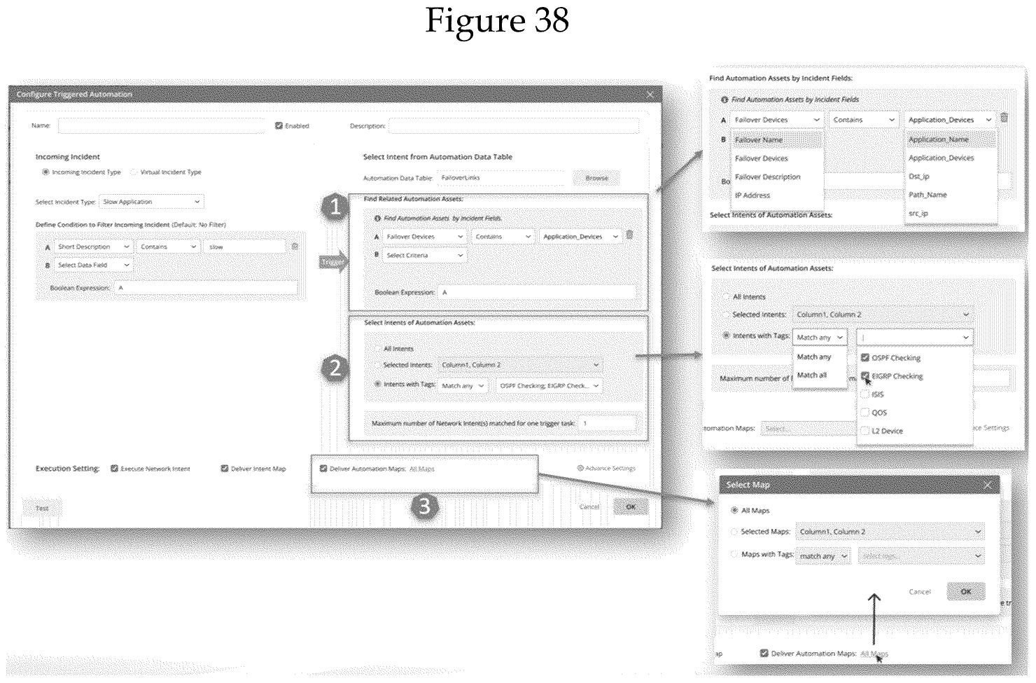

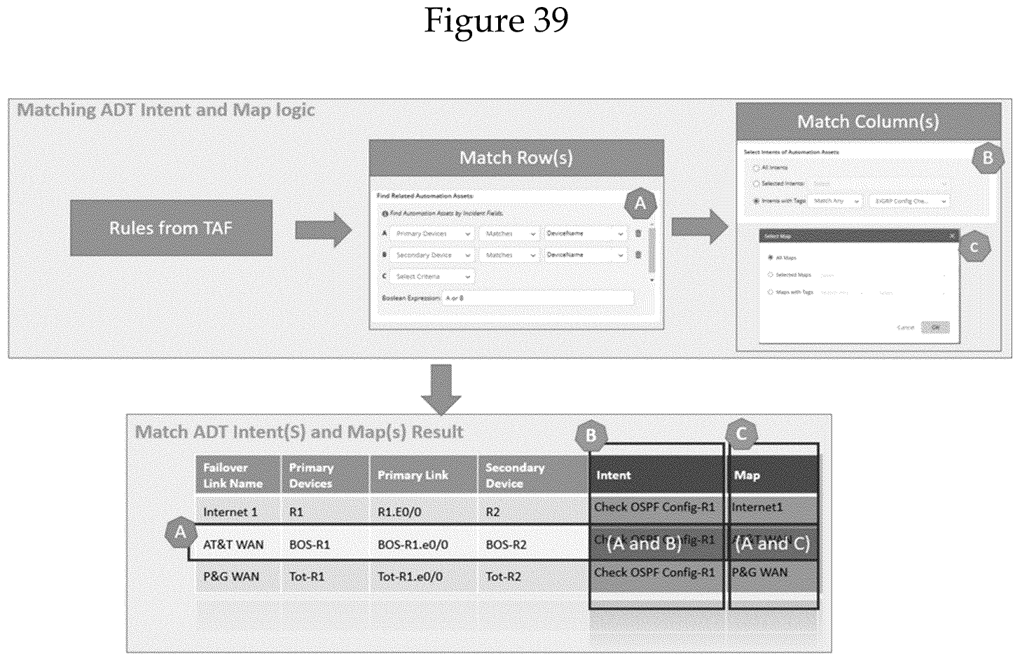

FIG. 38 illustrates an example interface for triggering ADT intent. In this example, related Automation Assets are found by matching row data based on whether the corresponding incident field exists in the ADT column. Then, associated intents of Automation Assets are triggered. All the intents of the matched ADT rows may be triggered by default, and the user can filter the intents to be executed with automation tags or manually choose intents by selecting columns. The Automation Maps of Automation Assets are delivered to the Incident pane. All the maps of the matched ADT rows may be delivered to the incident pane by default. Users may filter the delivered maps with automation tags or manually choose maps by selecting columns. FIG. 39 illustrates an example interface for matching ADT intents. FIG. 39 illustrates the logic for matching ADT intents in ADT-based TAF.

The diagnosis may be triggered using an Intent Template. The Intents can be replicated from the intent template for troubleshooting. In the process of installing the intent template to TAF, some macro variables of the intent template may need to be set to a certain specific value, e.g., the target subnet for the show ip route <subnet> command. To support TAF in these examples, users can enter values for macro variables of the intent template during the TAF installation. Data fields of incoming incident type may be used as the data source to set the value for macro variables.

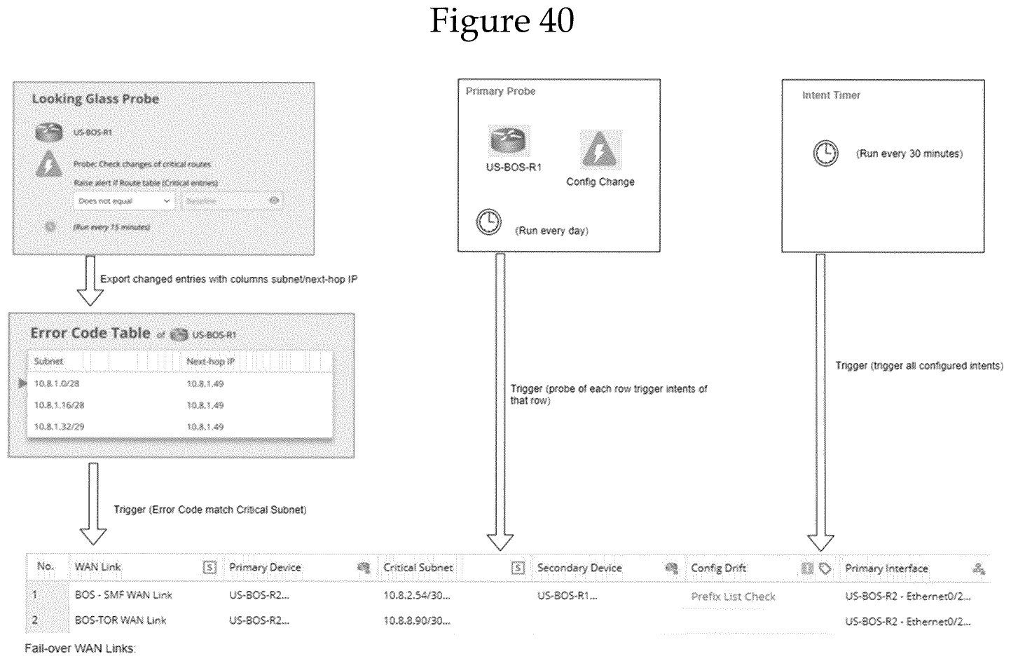

FIG. 40 illustrates an example interface for ADT configuration for preventative automation. ADT Intents may be installed for preventive automation. ADT can be installed in the Intent-Based Automation Center (IBA) for preventive automation. The PAF function based on ADT may be improved. For ADT-based PAF configuration, in order to ensure the critical assets defined within ADTs are functioning properly, the system executes the intents of ADT by preventive automation. In one example, this may be executed by a looking glass probe. The monitor status of a device may be retrieved via SNMP/CLI. Based on the alert data, the intents defined within ADT intents can be matched and executed. In another example, this may be executed by a Primary Probe: The intents may be triggered to be defined in the same row based on the probe column defined in the ADT table. In another example, this may be executed by an Intent Timer. The intent execution may be triggered based on the intent timer being pre-defined. In some embodiments, the monitoring probe may be improved to support ADT-based PAF function. There may be an Auto Probe to provide a quick way for power users to batch-create probes on a set of qualified devices or interfaces.

### ADT-Based Looking Glass Probe

A probe may perform diagnosis at the device level to determine its health status for a single device. Running a probe for the entire network may require the deployment of this probe on all devices, which may lead to inefficiencies and increased traffic for both network devices and the network management system. Alternatively, users can run the probe on a small set of devices (i.e., “looking glass probes”), which can detect any anomaly for the whole network. Then, these probes can parse alert information to identify problematic entries and trigger intent diagnosis for a larger group of devices.

An example of the looking glass probe includes a Route Table Check or a Neighbor Table Check. For the Route Table Check, a critical route is filtered from the show IP route, and the data is compared with the baseline to verify the routes remain the same. Any changed routes can be exported to the error code to trigger the corresponding intent diagnosis stored in ADT. For the Neighbor Table Check, the command, show ip bgp neighbor, may be used to compare the BGP neighbor status with baseline data to verify these neighbors are healthy. For any neighbor with issues/problems, the neighbor information can be exported to the error code to trigger the intent diagnosis stored in ADT.

Users can choose the appropriate looking glass probes to monitor the network health status while utilizing minimal resources on both network devices and the network management system. If the looking glass probe generates an alert and the error code matches the corresponding intents in the ADT table, the configured intents will be triggered. For example, a looking glass probe monitors the critical route status on a device. If there is any change in the routing entry for the looking glass probe, the changed entry (e.g., added, removed, and modified entries) will be exported into the error code. The error code can then be used to match the intents of ADT. Table 8 is an example of ADT for the critical WAN link asset.

TABLE 8
ADT for the critical WAN link asset.

| Failover | | | | | | |
|---|---|---|---|---|---|---|
| Link | Primary | | Secondary | Primary | | |
| Name | Device | Critical Route | Device | Link | Intent1 | Intent2 |
| Internet | R1 | 10.8.1.0/28 | R2 | R2.E0/0 | Monitor | Verify QOS |
| 1 | | | | | Failover | Config - Internet1 |
| | | | | | Link Health - | |
| | | | | | Internet1 | |
| AT&T | BOS-R1 | 192.168.10.0/24 | BOS-R2 | BOS- | Monitor | Verify QOS |
| WAN | | | | R2.e0/0 | Failover | Config - AT&T |
| | | | | | Link - | WAN |
| | | | | | AT&T | |
| | | | | | WAN | |
| P&G | Tot-R1 | 172.16.16.0/24 | Tot-R2 | Tot- | Monitor | Verify QOS |
| WAN | | | | R2.e0/0 | Failover | Config - P&G |
| | | | | | Link Health - | WAN |
| | | | | | P&G WAN | |

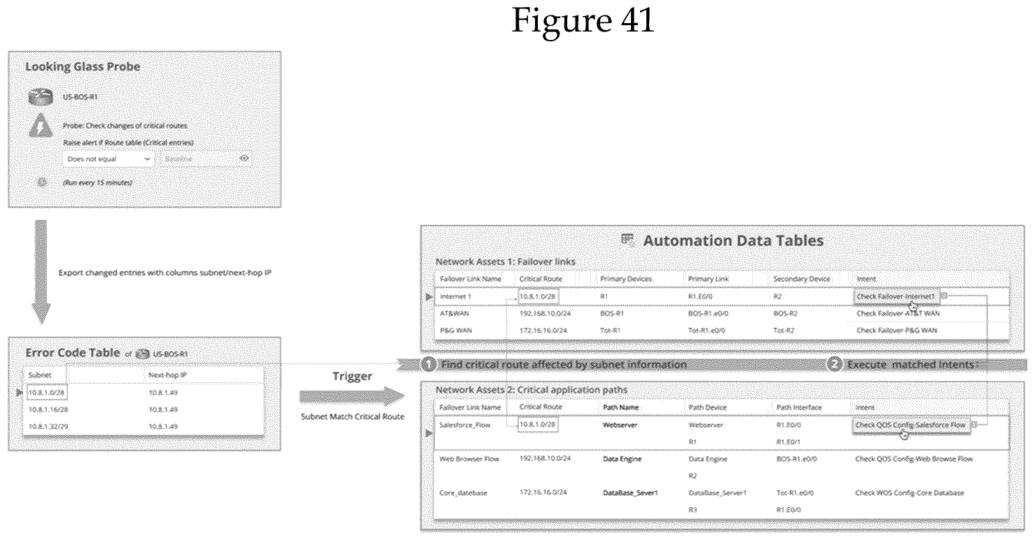

FIG. 41 illustrates an example of the looking glass probe for executing a matched intent. Based on the error code table contents, the subnet contents can be used to look up if there is any entry match. The error codes are generated by looking glass probe for several subnets, and the changed subnet information is exported from the routing table. The system matches these subnets with the ADT Table column “critical route” to check if any WAN link is affected and find the first Failover link that contains the affected critical route. Further, the system will trigger the intent execution (e.g., Monitor Failover Link Health-Internet1 and Verify QOS config-Internet1).

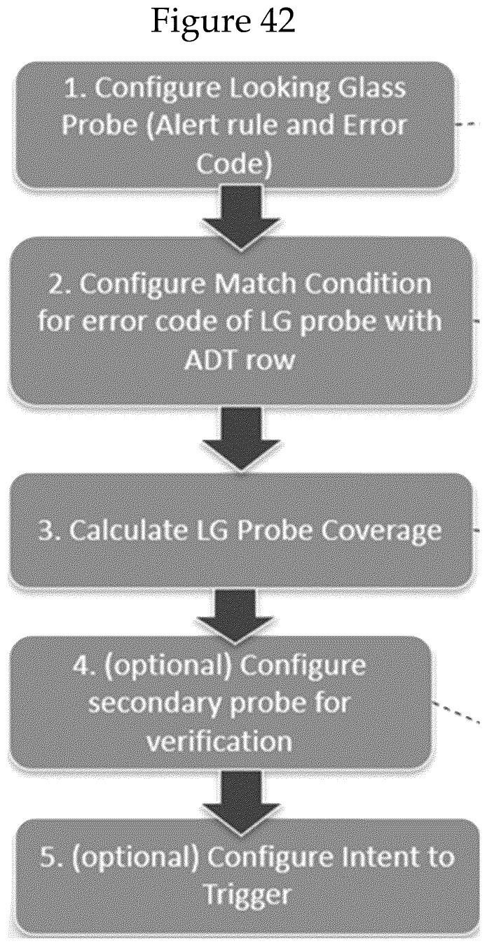

FIG. 42 illustrates an example process for ADT creation based on a looking glass probe. The process of configuring looking glass probes to trigger ADT may include: 1) comparing with baseline data and filtering rows/columns if needed; and 2) exporting error contents to an error code. For the comparison with baseline data and filtering rows/columns, the probe diagnosis results can be compared with baseline data that is initially stored when the probe is executed, and the data can be used as the baseline to check against further data. Table columns can be filtered by ADT table to keep critical ones or exclude less important items. Certain table columns can be filtered so that critical columns will be the focus. For the exporting of error contents, specified contents can be exported to the Error Code and can be used to match ADT columns.

The Looking Glass Probe can be used to monitor critical parameters that can be used to drive the diagnosis of related network devices, such as critical routes, topology neighbor check and routing neighbor check. In one example, there may be a Routing Table Check, where a user can use the command, show ip route, and filter the critical routes to compare the data with the baseline to verify the routes remain the same. Any changed routes can be exported to the error code to trigger the corresponding intent diagnosis stored in ADT. In a second example, there may be a Topology Neighbor Check, where a user can use the command, show CPD neighbor, or show LLDP neighbor, to figure out the neighbor change for a core device, and from the changed entries, you can trigger the diagnosis of neighboring devices. In a third example, there may be a Routing Neighbor Check, where a user can use the command, show IP BGP neighbor, and compare the BGP neighbor status with baseline data to verify whether these neighbors are healthy. If any neighbor has issues/problems, the neighbor information can be exported to the error code, further triggering the intent diagnosis stored in ADT. In other words, the looking glass probe may be installed to identify critical route changes and trigger the intent diagnosis for each critical route.

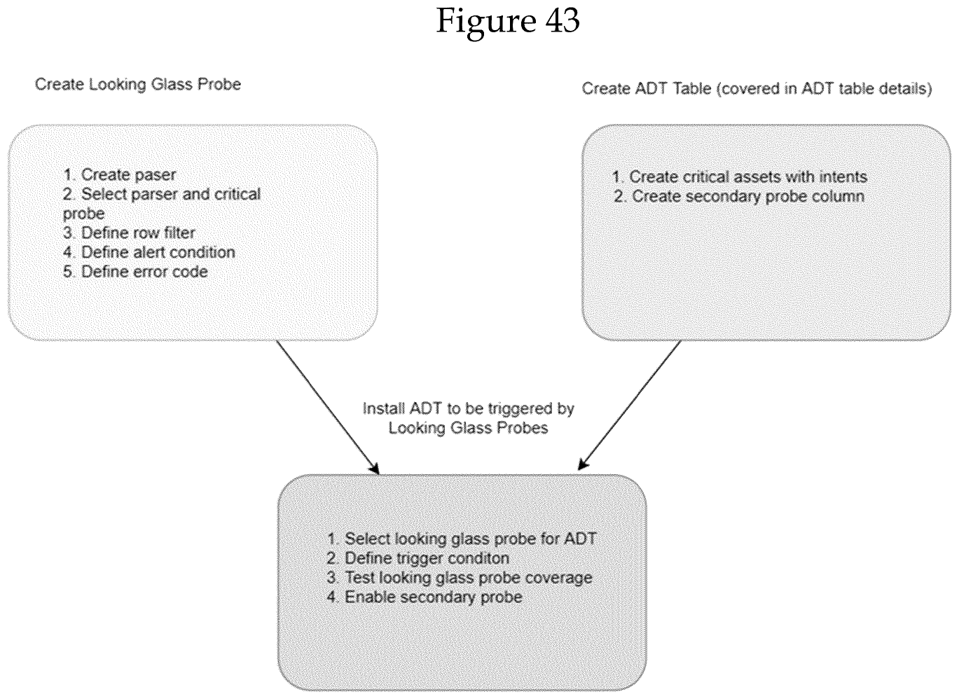

FIG. 43 illustrates an example process for ADT creation triggered by a looking glass probe. The creation of an ADT table triggered by the looking glass probe may include the creation of the looking glass probe, the creation of the ADT table, and the installation of the ADT to be triggered by the looking glass probe. The looking glass probe may be created to generate alerts. The ADT table is created for critical assets. The ADT is installed to be triggered by the looking glass probes.

A Primary Probe may be used to trigger the Intent of ADT. Looking glass probes may not be able to trigger all ADTs since some Intents may not find looking glass probes. In this example, there may be probes defined in the ADT column to trigger the intent execution. Users can add the primary probe column in the ADT tables, and the probe with its polling frequency can be executed periodically. The probe may trigger the configured intents within the same row if it creates any alert.

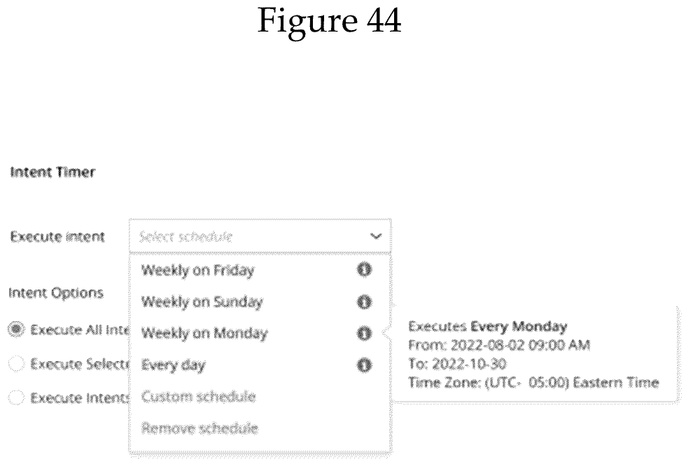

FIG. 44 illustrates an example interface for selecting an intent timer to trigger selected intents. An Intent Timer may be used to trigger Intents of ADT. Some ADTs may not be triggered by looking glass probes or primary probes. In this example, users may use the intent timer to run the intents of the ADT table periodically. To configure the ADT executed by the Intent timer, users can install the ADT with the trigger method via the Intent Timer. From the configuration window, a user can select the intent timer to trigger the selected intents.

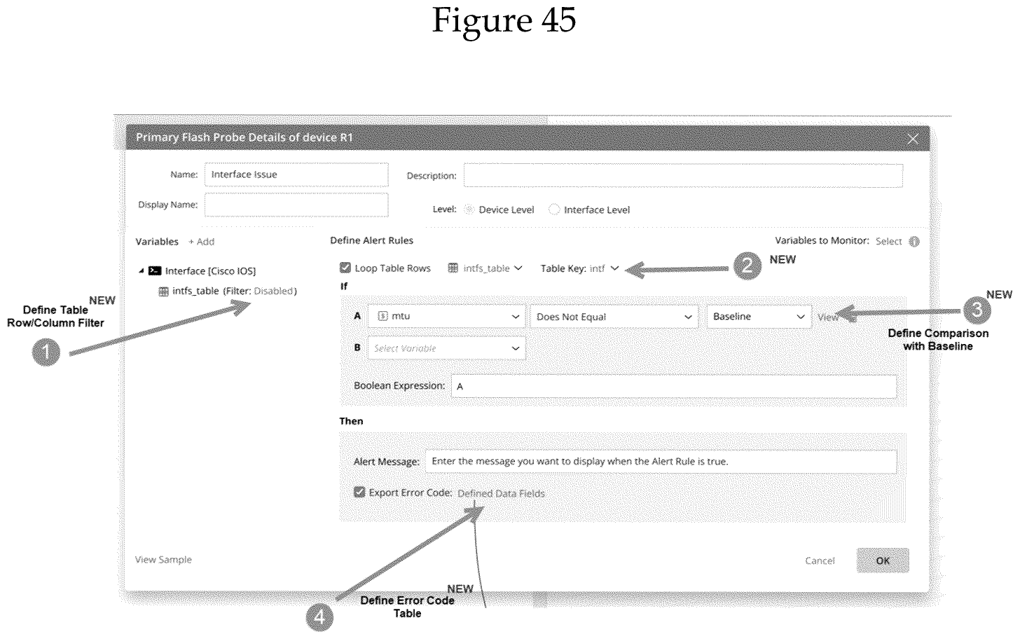

FIG. 45 illustrates an example interface for a monitoring probe. This may include improvements to support the looking glass probe. The improvement may include defining a table row/column filter to keep critical contents. This may include filter by column for selecting the columns to keep so the probe will diagnose only certain columns or filtering by row to use the ADT table as the source for filtering the parser table. Users can keep or filter certain rows to match with ADT table contents. The improvement may include defining a table key that can be defined directly within the probe. The table key compares the table rows against baseline/last values to identify unique rows. When looping table rows, it may be difficult to compare the table with the baseline/last value without the table key. The improvement may include defining comparison with baseline logic by using the baseline to define the comparison logic against baseline data. When the data is retrieved for the first time, the data may be saved and used as baseline data. The baseline data remains the same and may not change. If the baseline data does not match the current network status, the user can have a Clear Baseline function to clear the existing baseline. The system may further retrieve the data and use it as baseline data.

The improvement may include exporting the error code, where the error code triggers Intent execution within the ADT table. The error code column may be defined from the table or a single value used in the if condition. The table column may be used as an error code column besides the single value. The error code column can be further expanded with built-in data or by appending a column via the ADT table. The built-in data for this device: this device can be exported if an alert is generated, which is very useful when there are multiple looking glass devices and you want to define match conditions based on looking glass devices. Appending a column via the ADT table may be based on the error code to expand the column.

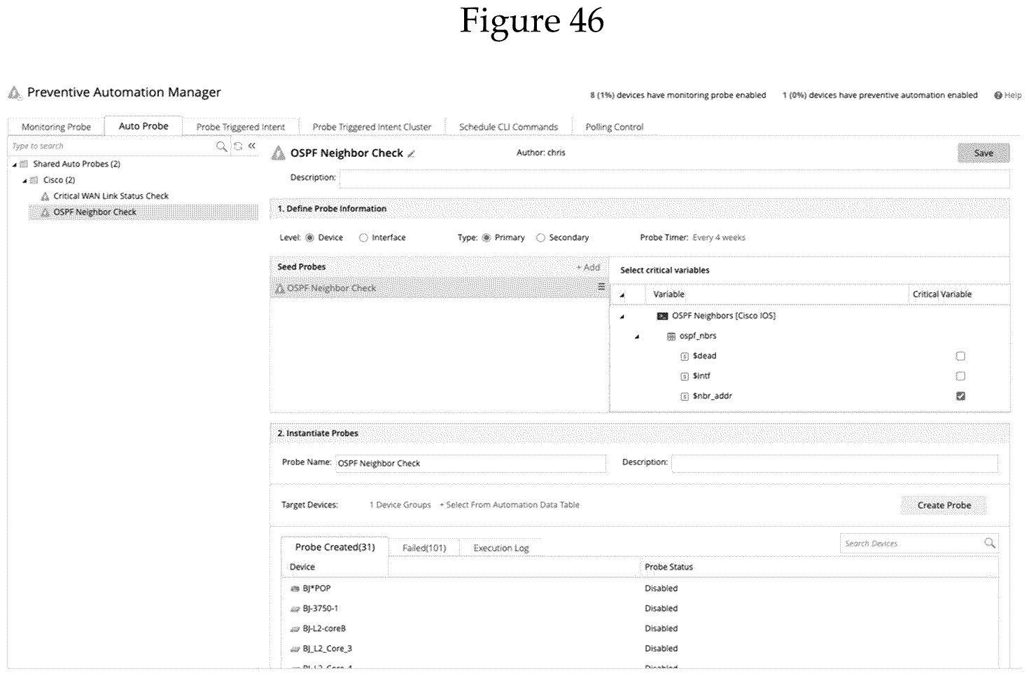

FIG. 46 illustrates an example interface for an auto probe. Auto Probe provides a quick way for power users to create probes from the seed probe(s) in batches on a set of qualified devices or interfaces. Sophisticated users can use these device/interface probes to set up the ADT-based PAF. Besides selecting the seed probes and target devices or interfaces, users can specify critical variables to identify whether the probe is qualified on the target device. With the critical variables, the system may test the critical variables against the live network and find the correct seed probe for a target device.

For intents triggered by looking glass probe or primary probe, there is a chance that the probe status is healthy and probes generate no alerts for some time. To ensure that these intents are executed even if no alert is generated, there may be a Last Resort Timer that can be configured for this condition. If certain intents are not triggered within the defined time frame, the system may further trigger the intents to execute.

For intents triggered by the looking glass probe or primary probe, if the probe generates alerts consecutively and a user does not want the intent to be triggered each time, there may be trigger suppression to specify the intents to be triggered once within the defined time frame.

Auto Intent allows users to create and run intents on a map. The auto intent may be for pre-qualified Automation Assets, where a folder structure displays and organizes ADT's network intent templates and automation assets (intent/map/path). Users can view and use the items by category. There may be an Intent Template enabled for Auto Intent. ADT Assets (e.g., Intents/Maps/Paths) of the enabled ADT and selected device/intents may be displayed. There may be an Intent Preview and/or Input for Macro Variables for previewing items highlighted or selected. The items highlighted in a Selected Device/Intents area may facilitate network intent selection or input values for macro variables of the target device to create proper intent. The user can run intent and view the execution results, then add the created intent as map/path/common intent for further troubleshooting.

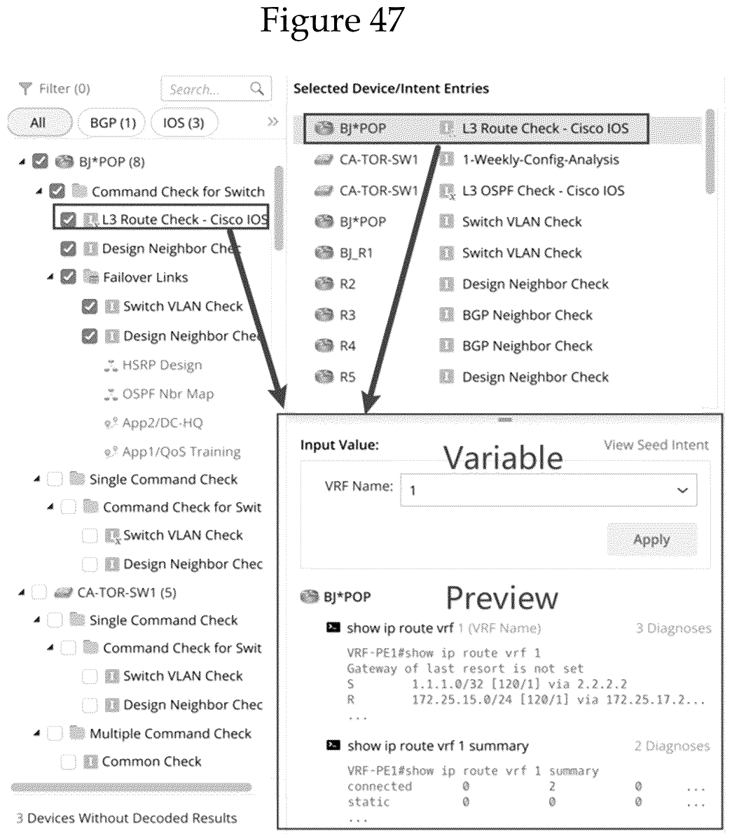

FIG. 47 illustrates an example interface for using the auto intent from an intent template. The auto intent may be used to create intent for map devices. Auto intent supports replicating the intent template with customizable macro variables. With this functionality, end users may replicate desired intent from an intent template by simply setting the macro variables. Users may preview the data of the intent template via the following two operations: 1) Click (unselect is OK) an item in the Pre-qualified Automation Assets pane to preview its macro variables and command data; or 2) Click an item in the Selected Device/Intent area to preview its macro variables and command data. If the intent template has macro variables defined, users can change the value, which will change the replication results. Apart from the intent templates already listed in Auto Intent, users can use additional ones not installed and displayed, giving users more flexibility to use intents in Auto Intent.

An Intent Template/ADT may be filtered using Auto Intent. The filter function of Auto Intent may be improved so that when there are too many items, users can find the ones needed by filtering the items. An independent pane may appear after clicking, making it easier to define the filter conditions centrally. The improved filter function leads users to pay more attention to the automation assets and network objects enabled for Auto Intent.

To fully understand and troubleshoot an issue, users may need to analyze the related maps and paths besides intents. By enabling ADT assets (Intent/Map/Path) to be used in Auto Intent, users can find automation assets for map devices, e.g., device-related failover links and the map, device-related path, and the path intents. With the available ADT assets in Auto Intent, users can use intents from ADT to create an intent for troubleshooting, view a map and use the map for troubleshooting, and/or view a path and use the path for troubleshooting.

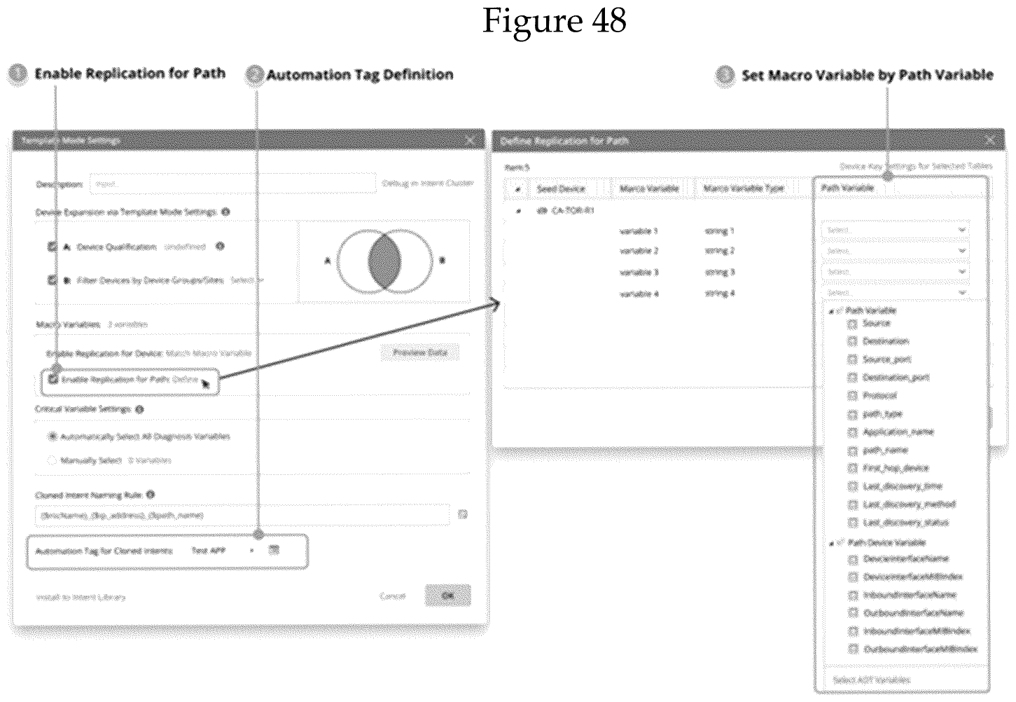

FIG. 48 illustrates an example interface for replicating path intent. ADT may be used to replicate path Intent. Path intent replication settings in the intent template (NIT) are provided. The system allows defining path macro variables or selecting ADT data sources as macro variables for an intent template to prepare for creating path intents. Specifically, path variables and path device variables may be used as the values of the macro variables of the intent template. There may be batch path intent replication from ADT. For example, a method, Intent Replication for Path, may be provided for building column groups in ADT, and multiple path intents can be delivered from ADT with the data in ADT for running troubleshooting diagnosis. There may be an on-demand path intent replication from the path browser/Auto Intent New. Users can set to replicate path intents by selecting the intent template from an open path or Auto Intent. One path may have multiple path intents.

The system supports creating path intents with the new intent replication for path service in ADT. This may include cloning path intents in batch through an intent template with the data source in ADT. In the Intent Replication for Path Service, ADT may serve as a tool to provide data to replicate path intents as scheduled. Specifically, users can add a group column to ADT via the “Intent Replication for Path” method. The available data fields include path intent and data fields of the path intent details. With the data in ADT, users can further set the variables for path intent replication. The created intents can be saved as path intents for future use. The path parameters may be passed to the Macro Variables of the seed NIT to clone a path NI.

There may be on-demand path intent replication from path browser/auto intent. Multiple path intents can be created and associated with one path, which enhances the capability of executing path intents for troubleshooting network issues from a path. All the path intents of a path are included in a “View” list in the Path Intent Pane. The path intent may be created by replicating the path intent via the Intent Template from the Path Detail Pane or by opening auto intent to create path intent for a path. After a path intent is created with the automation assets in Auto Intent, the created intent may be associated with a path and saved as its path intent.

The system offers several options for deleting/unlocking path intents in batch. There may be a batch Remove/Unlock Path Intents from Network Intent Manager: In Network Intent Manager>Path Intent, each path forms a folder to include all the associated path intents. Users can delete/unlock multiple path intents at one time in the pop-up Dialog opened from the drop-down menu. There may be a batch Remove/Unlock Path Intents from ADT Manager: for an ADT containing a Path Intent Column, users can delete/unlock multiple path intents at a time in the pop-up dialog from the drop-down menu of the Path Column.

### Follow-Up Diagnosis

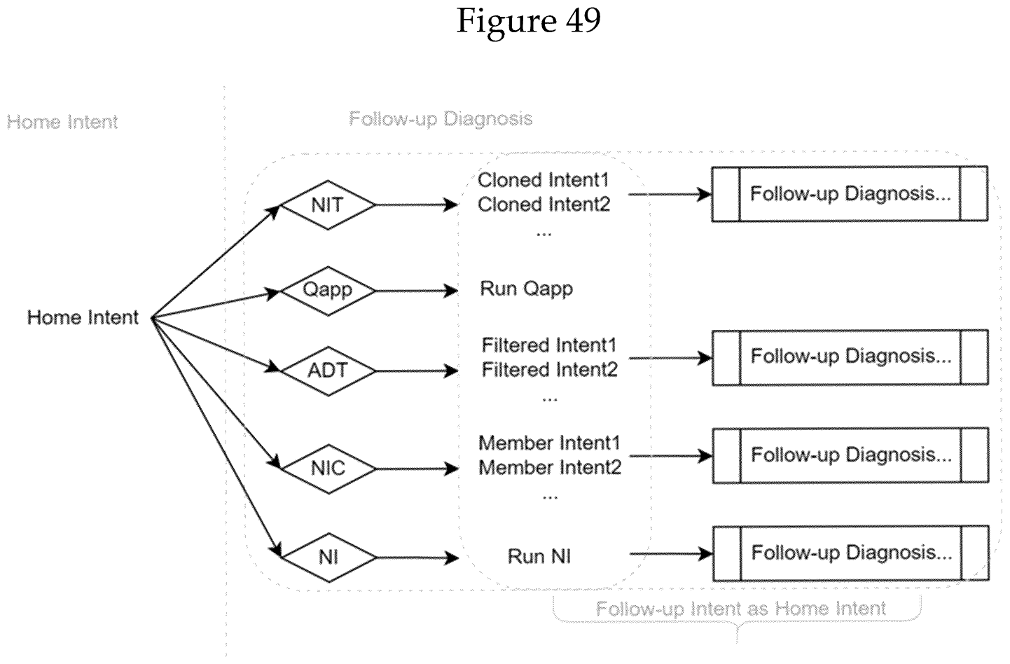

FIG. 49 illustrates example follow-up diagnoses. NI, NIC, NIT, Qapp, and the intents from ADT are all supported as follow-up logic. Compared with NIC, NIT and Qapp may not replicate member Intents in advance. Follow-up diagnosis enables multi-stage reasoning so that a follow-up intent can be taken as a home intent to do further follow-up diagnosis. There may be a follow-up Intent Template. An intent (home intent) can call a specified intent template to run the follow-up diagnosis, under which the diagnosis logic in the template can be applied to downstream devices calculated from the home intent. The home intent can also transfer other variables to the macro variables of the follow-up intent templates.

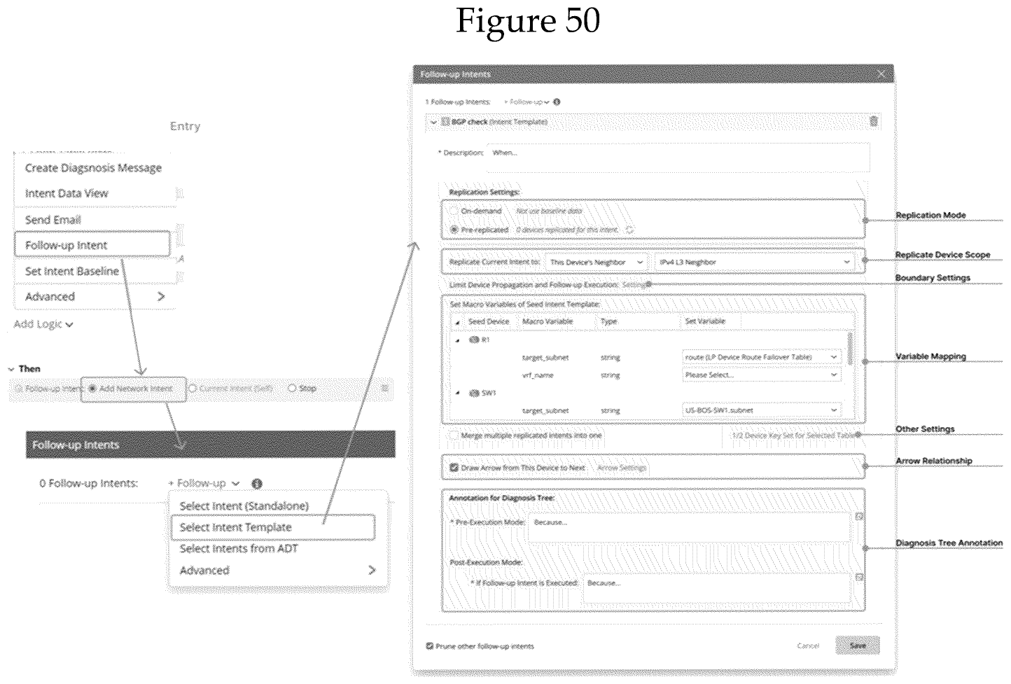

FIG. 50 illustrates an example interface for follow-up intent. The follow-up intent supports Replication Mode, which includes on-demand for retrieving the data from the live network or pre-replicated, which uses pre-decoded data (cached data). The follow-up intent supports replicating the Current Intent to this Device's Neighbor, IPv4 L3 Neighbor, IPv6 L3 Neighbor, and/or L2 Neighbor. The follow-up intent supports replicating Current Intent to devices by variable, where the range of variables that can be selected includes: $this_device; Device Variables under Calling Intent; Device Macro Variables under Calling Intent; and/or Global Variables under Calling Intent. The follow-up intent supports setting Macro Variables of the Follow-up Intent Template. The range of variables that can be selected is the same as the Device by Variable in Replicate Device Scope. The follow-up intent supports merging multiple replicated intents into one. By default, each device generates an intent. The follow-up intent supports setting a device key for a selected table. The device key may be set to match table variable values precisely. The follow-up intent supports drawing an arrow from this device to the next on the map. This arrow is from the current device to the next device whose intent is to be replicated. The follow-up intent supports annotation for the Diagnosis Tree. Annotations are displayed on the line of the Diagnosis Tree. The diagnosis tree of the follow-up intent template may be: 1) Pre-Execution Mode, where the basic information of the intent template is displayed on the left, and the information defined in the intent is displayed on the right; or 2) Post-Execution Mode, where the detailed results are displayed. Besides the diagnosis details and comparison details, the follow-up intents/Qapps/ADT may be displayed.

An Intent (home intent) may call itself as the follow-up intent template, under which the same logic will be applied to downstream devices calculated from the home intent. The logic may be recursively called upon until it hits a boundary defined by logic or maximum depth. Users may control when to hit the boundary by defining max depths and device scope:

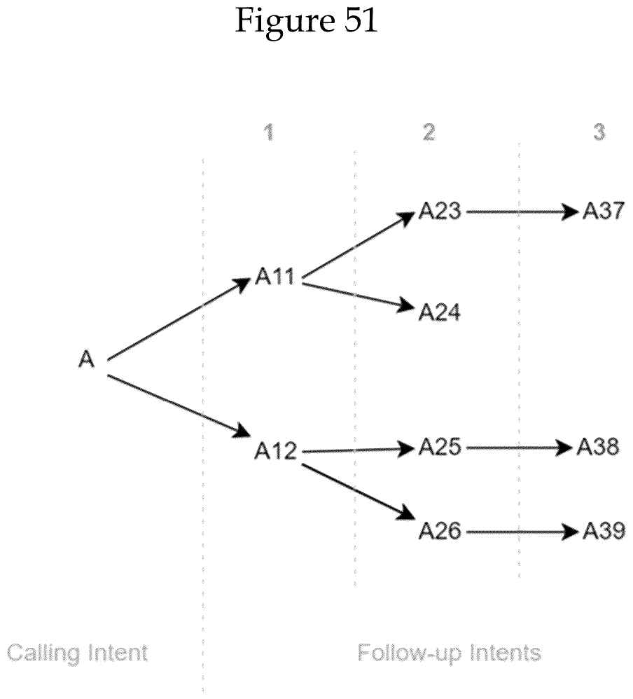

FIG. 51 illustrates an example of depths for follow-up intent. Users can set the max depths and follow-up intent count in Area 1. The user can also set the max command sections in one cloned intent in Area 2.

For defining the network scope in area 3, there may be a limit to the range of devices so that the devices beyond this range will not be replicated. When entering a border device, it will not continue to find its neighbors, but whether to clone the intent and continue the diagnosis on the current border device can be set. Device groups and sites can be selected for both selections, and multi-selection is supported. Recursive diagnosis from the current Device towards a Target IP self may be executed. A path can be drawn, or a recursive diagnosis may be executed across Multi-level Neighbors.

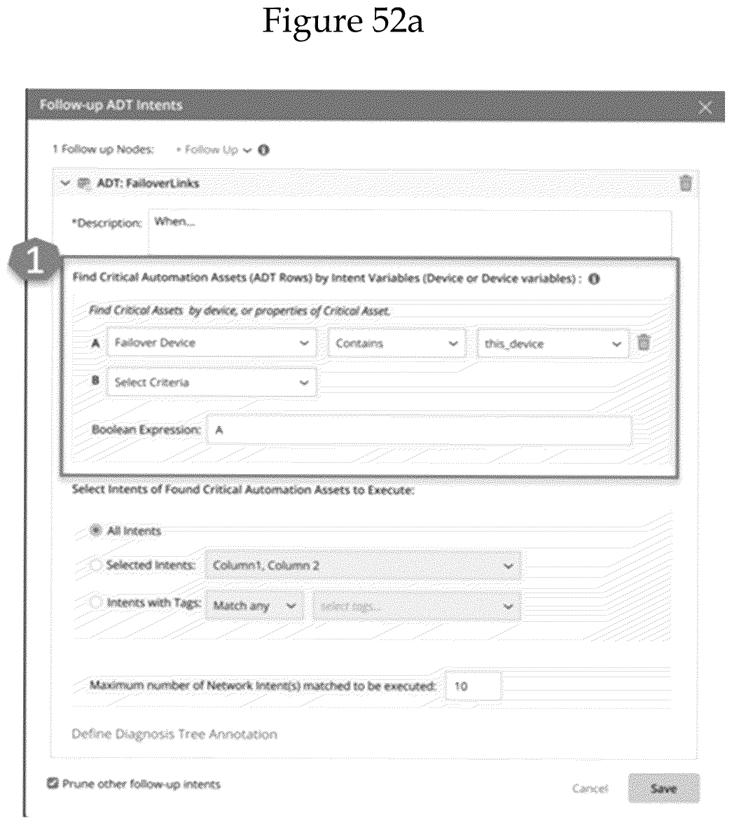

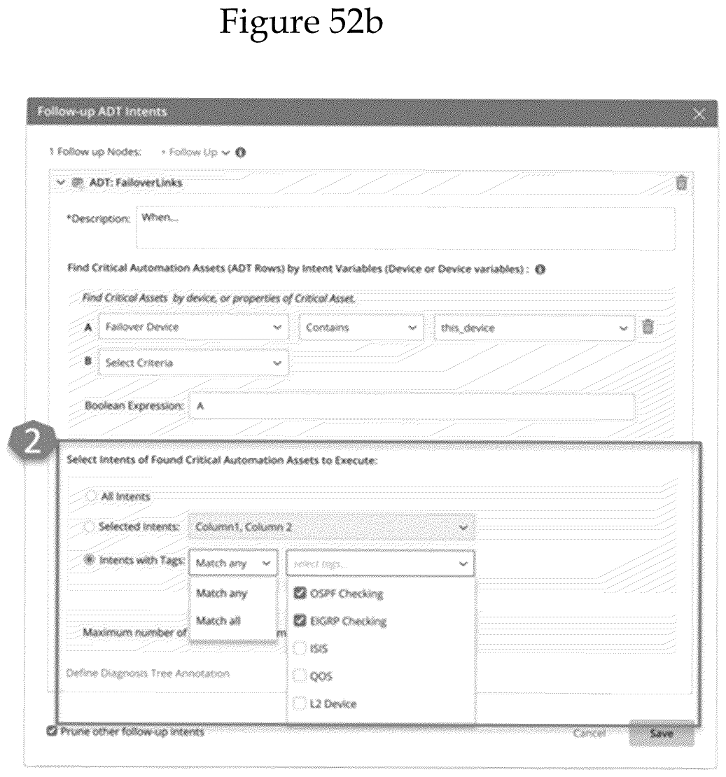

FIG. 52a illustrates an example interface for finding automation assets. FIG. 52b illustrates an example interface for selecting intent for automation assets. Automation Data Table (ADT) can reference multiple automation intent columns for each automation asset, and users can use intents (e.g., path intents) in ADT as follow-up diagnoses. The definition of follow-up ADT includes finding Automation Assets by Intent Variables (Context Device or other Device Variables), as in FIG. 52a; and/or selecting the Intent of Automation Assets to be executed as in FIG. 52b.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, communication interface, or non-volatile or volatile memory in communication with a transmitter. A circuit or electronic device is designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for utilizing an automation data table (ADT) in the network assessment and troubleshooting, the method comprising:
receiving the ADT including associations of ADT data in the ADT;
associating the ADT data with information about automation assets;
automating network assessment and monitoring of a network based on the ADT; and
automating troubleshooting a network problem based on the ADT.

2. The method of claim 1, where the automation is intent-based.

3. The method of claim 1, wherein the ADT comprises a global data table for managing critical network assets and network intents associated with the critical network assets.

4. The method of claim 3, wherein populating of the ADT data is based on an intent template (NIT), a network intent cluster, a map folder, sites, device groups, an external file, or network applications and their paths.

5. The method of claim 3, wherein the ADT comprises a database for intents, and supports intent creation and replication.

6. The method of claim 1, further comprising:
assessing an entire network for the hidden issues with the ADT.

7. The method of claim 6, further comprising:
benchmarking the network data, saving the data with ADT, and assessing the network with the data stored in the ADT.

8. The method of claim 1, further comprising:
updating the ADT data periodically.

9. The method of claim 1, wherein the ADT data comprises a path, application, critical WAN link, critical device failover, critical subnet, or critical route.

10. The method of claim 1, wherein the associations comprise network intents and the ADT data.

11. The method of claim 1, further comprising executing all intents of an ADT once.

12. The method of claim 1, further comprising displaying the intent results in a dashboard.

13. The method of claim 1, further comprising:
associating a network problem with the ADT and executing an intent diagnosis by matching the problem with an ADT entry.

14. A method for generating an automation data table (ADT), the method comprising:
generating the base table for the network assets;
associating the automation assets with the network assets; and
generating the diagnosing results using the determined intent with organized assets.

15. The method of claim 14, wherein the assets comprise critical network assets such as Application and Path, WAN Link, Device Failover, Critical Subnets and Routes.

16. The method of claim 14, wherein the generating further comprises:
utilizing an Automation Data Table Builder to allow a user to build the base table and bind the intent for each of the assets.

17. The method of claim 16, wherein the base table is created by an intent template, an intent cluster, an application path, a map folder, or a device group.

18. The method of claim 16, wherein the base table is created from an external resource, such as importing from a CSV file.

19. The method of claim 16, where the intents of assets are populated by an intent template, or an intent cluster.

20. A method of claim 14, further comprising:
updating, automatically, the intent stored in the ADT;
and providing an interface for updating the ADT.

21. A method of claim 11, further comprising: tagging an intent column so that the intent column can be called via the tag.
